(19) United States
(12) Patent Application Publication
(10) Pub. No.: US 2007/0168286 A1
(43) Pub. Date: Jul. 19, 2007

(54) Content use management device

(75) Inventors: Nobuo Nishioka, Tokyo (JP); Atsushi Saso, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 10/597,029

(22) PCT Filed: Dec. 3, 2004
(86) PCT No.: PCT/JP04/18043

§ 371 Date: Jul. 7, 2006

(30) Foreign Application Priority Data
Jan. 9, 2004 (JP) 2004-004202
Sep. 16, 2004 (JP) 2004-269838

(51) Int. Cl. G06Q 99/00

(52) U.S. Cl. 705/51

(57) ABSTRACT

To provide a content usage management device capable of correctly determining limitation-on-usage information about contents, such as an expiration date.

A memory card 2 has a storage section 22 for storing coupon data 221 and expiration date data 222 as information about contents, and a processing section 21 for performing processing pertaining to the contents. When information about the time of the portable terminal 1 has been changed, card control means 212 of the processing section 21 detects a change-of-time event; acquires the current time of the portable terminal 1 achieved before and after the change of time, by way of data communications means 211; and updates the expiration date data 222 stored in the memory card 2 in accordance with the time information. When the expiration date of the coupon is determined, the expiration date data 222 stored in the memory card 2 are compared with the current time of the portable terminal 1, to thus determine whether or not the coupon is valid.

### FIELD OF THE INVENTION

The present invention relates to a content usage management device for managing usage of contents which are formed from electronic information and whose usage is limited, such as coupons, tickets, or the like.

### BACKGROUND ART

In a system, such as an electronic coupon, which has been proposed in place of related coupons or tickets formed from paper printed information, contents formed from electronic information, such as coupons or tickets, are stored in a storage medium of a terminal such as a cellular phone. By means of possession of the terminal including the contents, a function analogous to the coupon, the ticket, or the like, is realized. A system using such contents must properly manage an expiration date set for the contents in order to pose appropriate limitations on usage of the stored contents.

An apparatus, which has been proposed as an expiration date management apparatus of this type, manages an expiration date set on a medium when transaction processing, or the like, is performed by utilization of a medium such as a magnetic card or the like. This related-art expiration date management apparatus reads the information recorded on a medium by means of a terminal to thus grasp an expiration date registered in the medium; and compares the expiration date with the current time grasped at the terminal, to thus determine whether or not the medium falls within a term of validity (see, Patent Document 1).

Conventionally, in a case where the terminal itself determines the expiration date of the contents at the time of management of the expiration date of the contents stored in such a terminal, time information is acquired by a built-in clock in the terminal, and a determination is made as to whether or not the expiration date has passed on the basis of the thus-acquired time information. Consequently, when a difference exists, from the beginning, between time information about the terminal and time information about an apparatus of a content provider, such as a content server or the like, at the time of acquisition of contents or when the time information about the terminal has been changed by means of modification of the clock of the terminal after acquisition of contents, the expiration date of the contents cannot be determined properly. When an error has arisen in determination of the expiration date of the contents, appropriate limitations cannot be imposed on usage, which in turn impedes utilization of contents.

Patent Document 1: JP-A-7-44664

### DISCLOSURE OF THE INVENTION

### Problem to be Solved by the Invention

The present invention has been conceived in light of the circumstances and aims at providing a content usage management device capable of properly determining limitation-on-usage information such as an expiration date of contents, or the like.

### MEANS FOR SOLVING THE PROBLEMS

A content usage management device of the present invention is a content usage management device for managing usage of contents available at a terminal, comprising change-of-time detection means for detecting a change-of-time event at a terminal which uses the contents, and control means for updating limitation-on-usage information about the contents in accordance with the detected change of time.

By means of this configuration, even when a change-of-time event has arisen in the terminal which utilizes contents, the limitation-on-usage information about contents can be appropriately updated. A determination is made as to whether or not contents are usable by properly utilizing the limitation-on-usage information, such as an expiration date of contents or the like.

One mode of the present invention includes the content usage management device which further comprises content storage means for storing the contents, and limitation-on-usage information storage means for storing the limitation-on-usage information about the contents.

By means of this configuration, the limitation-on-usage information stored in the limitation-on-usage information storage means can be appropriately updated, and a determination can be properly made as to whether or not the contents stored in the content storage means are usable. Thus, management of usage of the contents is facilitated.

One mode of the present invention includes the content usage management device, wherein the limitation-on-usage information includes expiration date information showing an expiration date by which the contents can be used.

By means of this configuration, a correct determination can be readily made as to whether or not contents are usable, by use of expiration date information as the limitation-on-usage information about contents.

One mode of the present invention includes the content usage management device which further comprises data communications means for transmitting and receiving data to and from the terminal which uses the contents, wherein, when the contents are acquired, the data communications means transmits and receives data to and from a content distributor which distributes the contents, acquires a remaining time of validity of the contents from the content distributor, and acquires a current terminal time from the terminal, and the control means adds the remaining time of validity to the current terminal time, to thus compute the expiration date.

By means of this configuration, at the time of acquisition of contents, the expiration date information about contents can be appropriately computed from the remaining time of validity of contents and the current time of the terminal.

One mode of the present invention includes the content usage management device, wherein the control means compares the current terminal time acquired from the terminal with the expiration date, to thus determine whether or not the contents are usable.

By means of this configuration, a correct determination can be made as to whether or not contents are usable without accessing a server of the content distributor or the like, by utilization of time information about the terminal.

One mode of the present invention includes the content usage management device, wherein, when the change-of-time detection means has detected a change-of-time event of the terminal, the control means subtracts a current terminal time achieved immediately before change of the terminal time from the expiration date to thus compute a remaining time of validity achieved immediately before change of the terminal time, and adds the remaining time of validity achieved immediately before change of the terminal time to the current time of the terminal achieved immediately after change of the terminal time to thus compute an expiration date achieved immediately after change of the terminal time, thereby updating the limitation-on-usage information.

By means of this configuration, when a change-of-time event has arisen in the terminal, expiration date information about contents can be appropriately updated on the basis of the time information about the terminal achieved before and after change of time of the terminal without accessing a server of the content distributor or the like.

One mode of the present invention includes the content usage management device, wherein, when the change-of-time detection means has detected a change-of-time event of the terminal, the data communications means acquires from the terminal a current time thereof achieved immediately before change of time of the terminal and a current time of the terminal achieved immediately after change of time of the terminal.

By means of this configuration, when a change-of-time event has arisen in the terminal, a current time of the terminal achieved immediately before change of time of the terminal and a current time of the terminal achieved immediately after change of time of the terminal are acquired from the terminal, whereby the expiration date information about contents can be appropriately updated.

One mode of the present invention includes the content usage management device which further comprises data communications means for transmitting and receiving data to and from the terminal which uses the contents, and a storage section having content storage means for storing the contents and limitation-on-usage information storage means for storing information about limitations on usage of the contents, and being configured so as to be removably attached to the terminal, wherein, when the storage section is attached to the terminal, the data communications means transmits and receives data to and from a content distributor which distributes the contents and acquires from the content distributor a remaining time of validity of the contents, and the control means adds the remaining time of validity to a current time of the terminal, to thus compute the expiration date, and stores the expiration date into the limitation-on-usage information storage means.

By means of this configuration, when a terminal is attached, the expiration date information about contents can be appropriately updated on the basis of the remaining time of validity of contents and the current time of the terminal. Therefore, even when a medium including a storage section for storing contents is removably attached to the terminal, the expiration date of contents can be correctly determined.

One mode of the present invention includes the content usage management device, wherein the data communications means acquires from the terminal a current time thereof when the storage section is attached to the terminal.

By means of this configuration, when the terminal is attached, the current time of the terminal is acquired from the same, and the expiration date of contents can be appropriately updated.

One mode of the present invention includes the content usage management device, wherein the limitation-on-usage information includes expiration date information showing an expiration time by which the contents can be used and reference time information showing a reference time which serves as a reference for limitations on usage of the contents.

By means of this configuration, the expiration date information and the reference time information are used as the limitation-on-usage information about contents, a correct determination can be made as to whether or not the contents are usable.

One mode of the present invention includes the content usage management device which further comprises data communications means for transmitting and receiving data to and from a terminal which uses the contents, wherein, when the contents are acquired, the data communications means transmits and receives data to and from a content distributor which distributes the contents, acquires a remaining time of validity of the contents from the content distributor as the expiration date, and acquires from the terminal a current time thereof as the reference time.

By means of this configuration, at the time of acquisition of contents, the expiration date information about contents and the reference time information can be appropriately computed from the remaining time of validity of contents and the current time of the terminal.

One mode of the present invention includes the content usage management device, wherein the control means subtracts the reference time from the current time of the terminal acquired thereof to thus compute a time during which the contents have been used, and compares the time during which the contents have been used with the expiration time, thereby determining whether or not the contents are usable.

By means of this configuration, a correct determination can be made as to whether or not the contents are usable without accessing a server of the content distributor or the like, by utilization of time information about the terminal.

One mode of the present invention includes the content usage management device, wherein, when the change-of-time detection means has detected a change-of-time event of the terminal, the control means computes a time during which the contents have been used, by means of subtracting the reference time from the current time of the terminal, computes an expiration date achieved immediately after change of the time of the terminal by means of subtracting the time during which the coupon has been utilized from the expiration time achieved immediately before the change of time of the terminal, and updates limitation-on-usage information by means of taking the current time of the terminal achieved immediately after change of the time of the terminal as a new reference time.

By means of this configuration, when a change-of-time event has arisen in the terminal, the expiration date information about contents and the reference time information can be appropriately updated on the basis of the time information about the terminal achieved before and after change of time of the terminal without accessing a server of the content distributor or the like.

One mode of the present invention includes the content usage management device, wherein, when the change-of-time detection means has detected a change-of-time event of the terminal, the data communications means acquires from the terminal a current time thereof achieved immediately before change of time of the terminal and a current time of the terminal achieved immediately after change of time of the terminal.

By means of this configuration, when a change-of-time event has arisen in the terminal, a current time of the terminal achieved immediately before change of time of the terminal and a current time of the terminal achieved immediately after change of time of the terminal are acquired from the terminal, whereby the expiration date information about contents and the reference time information can be appropriately updated.

One mode of the present invention includes the content usage management device which further comprises data communications means for transmitting and receiving data to and from the terminal which uses the contents, and a storage section having content storage means for storing the contents and limitation-on-usage information storage means for storing information about limitations on usage of the contents, and being configured so as to be removably attached to the terminal, wherein, when the contents are acquired, the data communications means transmits and receives data to and from a content distributor which distributes the contents, and acquires from the terminal a current time thereof achieved at the time of acquisition of contents, and wherein, when the storage section is attached to the terminal, the data communications means acquires from the content distributor a current time thereof achieved at the time of attachment of the storage section, and the control means subtracts the current time of the content distributor achieved at the time of acquisition of the contents from the current time of the content distributor achieved at the time of attachment of the storage section to thus compute a time during which the contents have been used until attachment of the storage section, subtracts the time during which the contents have been used from a previous expiration date stored in the limitation-on-usage information storage means to thus compute an expiration date achieved after attachment of the storage section, and stores the expiration date into the limitation-on-usage information storage means.

By means of this configuration, at the time of acquisition of contents, the expiration date information about contents and the reference time information can be computed from a remaining time of validity of the contents, the current time of the content distributor, and the current time of the terminal. When the content usage management device is attached to the terminal, the expiration date information about contents can be appropriately updated on the basis of the current time of the content distributor. Therefore, even when the medium including the storage section storing contents is removably attached to the terminal, the expiration date of contents can be correctly determined.

One mode of the present invention includes the content usage management device, wherein, when the storage section is attached to the terminal, the data communications means acquires from the terminal a current time thereof, and the control means stores the acquired current time of the terminal in the limitation-on-usage information storage means as a reference time achieved after attachment of the storage section.

By means of this configuration, when the terminal is attached, the current time of the terminal is acquired from the same, and information about the reference time of contents can be appropriately updated.

One mode of the present invention includes the content usage management device which further comprises current time acquisition means for independently acquiring from the terminal a current time thereof. By means of this configuration, the content usage management device independently acquires the current time from the terminal, and appropriately updates the limitation-on-usage information such as the expiration date of contents or the like.

A memory card device of the present invention is a memory card device having a content usage management function, the device comprising content storage means for storing contents available at a terminal, limitation-on-usage information storage means for storing limitation-on-usage information about the contents, data communications means for transmitting and receiving data to and from the terminal which uses the contents, change-of-time detection means for detecting a change-of-time event of the terminal, and control means for updating limitation-on-usage information about the contents in accordance with the detected change of time.

By means of this configuration, when a change-of-time event has arisen in the terminal which utilizes contents, the memory card device itself can appropriately update the limitation-on-usage information about contents without accessing a server of a content distributor or the like, and a determination can be made as to whether or not the contents are usable, by correct utilization of the limitation-on-usage information, such as the expiration date of contents, or the like.

The present invention also provides a portable terminal device having means of the content usage management device described in connection with any of the above modes. As a result of the portable terminal device being provided with respective means of the content usage management device, even when a change-of-time event has arisen in the terminal, the terminal can appropriately update limitation-on-usage information about contents without accessing a server of a content distributor or the like.

One mode of the present invention includes the portable terminal device which further comprises display means for displaying the updated limitation-on-usage information. By means of this configuration, the updated limitation-on-usage information is displayed, whereby the user can readily ascertain the updated information.

A content usage management method of the present invention is a method for managing usage of contents which are available at a terminal, comprising a step of detecting a change-of-time event of a terminal which uses the contents, and a step of updating limitation-on-usage information about the contents in accordance with the detected change of time.

By means of the steps, when the change-of-time event has arisen in the terminal that utilizes contents, the limitation-on-usage information about contents can be appropriately updated. A determination can be made as to whether or not the contents are usable, by correct utilization of the limitation-on-usage information, such as the expiration date of contents.

The present invention also provides a program for causing a computer to execute the above-described respective steps of the method for managing usage of contents. By means of this program, when the change-of-time event has arisen in the terminal which utilizes contents, the limitation-on-usage information about contents can be appropriately updated. A determination can be made as to whether or not the contents are usable, by correct utilization of the limitation-on-usage information such as the expiration date of contents.

### ADVANTAGE OF THE INVENTION

The present invention can provide a content usage management device capable of correctly determining limitation-on-usage information, such as the expiration date of contents or the like.

### BRIEF DESCRIPTION OF THE DRAWINGS

FIG. 1 A view showing an example configuration of a content utilization system according to an embodiment of the present invention.

FIG. 2 A view showing the schematic configuration of the content utilization system including a memory card according to the embodiment of the present invention.

FIG. 3 A view showing the functional configuration of the memory card according to a first embodiment of the present invention.

FIG. 4 A view showing the functional configuration of a portable terminal according to the embodiment of the present invention.

FIG. 5 A view showing general operation performed for determining the validity of coupon data in a first embodiment.

FIG. 6 A flowchart showing operation procedures of a memory card 2 of the first embodiment.

FIG. 7 A view showing a specific example operation performed at the time of acquisition of a coupon in the first embodiment.

FIG. 8 A view showing a specific example operation performed when the coupon is determined to be invalid in the first embodiment.

FIG. 9 A view showing a specific example operation performed when the coupon is determined to be valid in the first embodiment.

FIG. 10 A view showing a specific example operation performed when the time of a terminal is changed in the first embodiment.

FIG. 11 A view showing a specific example operation performed at the time of attachment of a card in the first embodiment.

FIG. 12 A view showing a specific example operation performed at the time of acquisition of expiration date information about the coupon in the first embodiment.

FIG. 13 A view showing the functional configuration of the memory card according to a first modification of the first embodiment.

FIG. 14 A flowchart showing operation procedures of the memory card according to a second modification of the first embodiment.

FIG. 15 A view showing a specific example operation performed at the time of acquisition of a coupon in a third modification of the first embodiment.

FIG. 16 A view showing the functional configuration of the memory card according to a second embodiment of the present invention.

FIG. 17 A view showing general operation performed for determining the validity of coupon data in the second embodiment.

FIG. 18 A flowchart showing operation procedures of a memory card 2 of the second embodiment.

FIG. 19 A view showing a specific example operation performed at the time of acquisition of a coupon in the second embodiment.

FIG. 20 A view showing a specific example operation performed when the coupon is determined to be invalid in the second embodiment.

FIG. 21 A view showing a specific example operation performed when the coupon is determined to be valid in the second embodiment.

FIG. 22 A view showing a specific example operation performed when the time of a terminal is changed in the second embodiment.

FIG. 23 A view showing a specific example operation performed at the time of attachment of a card in the second embodiment.

FIG. 24 A view showing a specific example operation performed at the time of acquisition of expiration date information about the coupon in the second embodiment.

FIG. 25 A view showing the functional configuration of a memory card according to a first modification of the second embodiment.

FIG. 26 A flowchart showing operation procedures of a memory card according to a second modification of the second embodiment.

FIG. 27 A view showing a specific example operation performed at the time of acquisition of a coupon in a third modification of the second embodiment.

### DESCRIPTIONS OF THE REFERENCE NUMERALS

1 PORTABLE TERMINAL
2 MEMORY CARD
3 COUPON SERVER
4 NETWORK
21 PROCESSING SECTION
211 DATA COMMUNICATIONS MEANS
212 CARD CONTROL MEANS
22 STORAGE SECTION
221 COUPON DATA
222 EXPIRATION DATE DATA
223 REFERENCE TIME DATA
224 REMAINING-TIME-OF-VALIDITY DATA
225 COUPON ACQUISITION TIME DATA

### BEST MODES FOR IMPLEMENTING THE INVENTION

The present embodiment shows, as an example content usage management device, a system which utilizes contents formed from electronic information, such as a coupon or a ticket, by use of a portable terminal such as a cellular phone or the like. There will now be described an example configuration for implementing the function of a content usage management device which manages limitations on usage of contents by means of a memory card which can be attached to a portable terminal and stores the contents.

### First Embodiment

FIG. 1 is a view showing an example connection configuration of a content utilization system according to an embodiment of the present invention. A memory card 2 has the function of a content usage management device; and comprises memory for storing contents having expiration dates and a card-like recording medium having a connection interface or the like. For instance, an SD card is used for the memory card 2, and the memory card 2 is used while being removably attached to a portable terminal 1.

The portable terminal 1 is connected to a coupon server 3 of a content distributor which provides coupons, by way of a telephone line forming communications lines or a network 4 such as the Internet. This portable terminal 1 is communicable with another portable terminal (not shown) by way of the network 4 or another network (not shown). The coupon server 3 issues electronic coupons, which can be used in shops or the like, as contents having expiration dates; and provides the contents to the portable terminal 1 by way of the network 4 by means of transmission. In the present embodiment, there will be described a case where coupons are utilized as example contents. However, the contents are not limited to the coupons, and the present invention can also be applied to electronic tickets such as movie tickets or concert tickets.

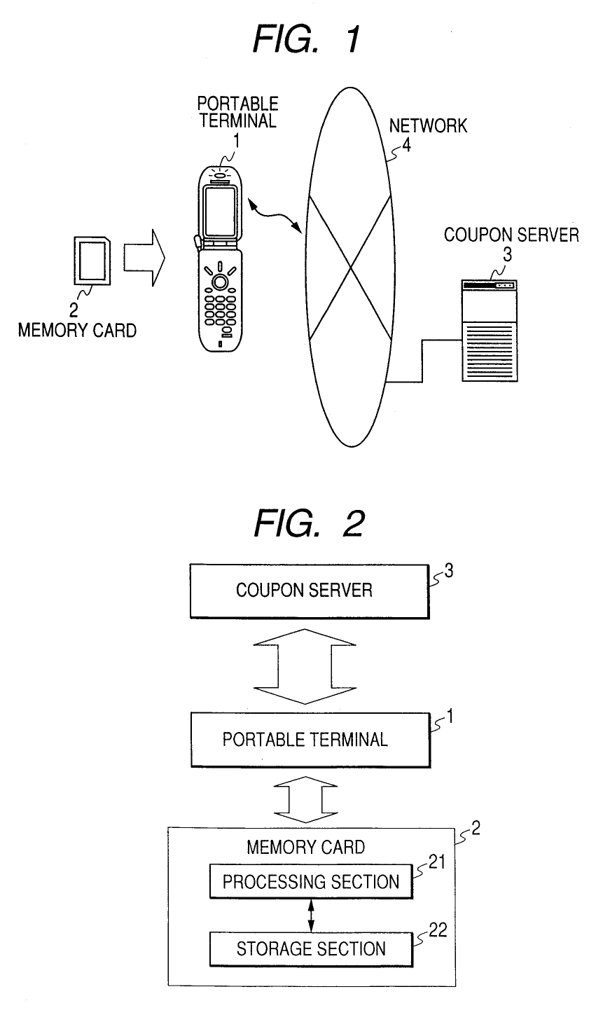

FIG. 2 is a view showing the schematic configuration of the content utilization system including a memory card according to the embodiment of the present invention. The memory card 2 comprises an IC chip including a processing section 21 having a processor function and a storage section 22 having a memory function. Coupon data, or the like, are stored in the storage section 22. The processing section 21 performs processing such as communication of data with the portable terminal 1 and communication of data with the coupon server 3 by way of the portable terminal 1.

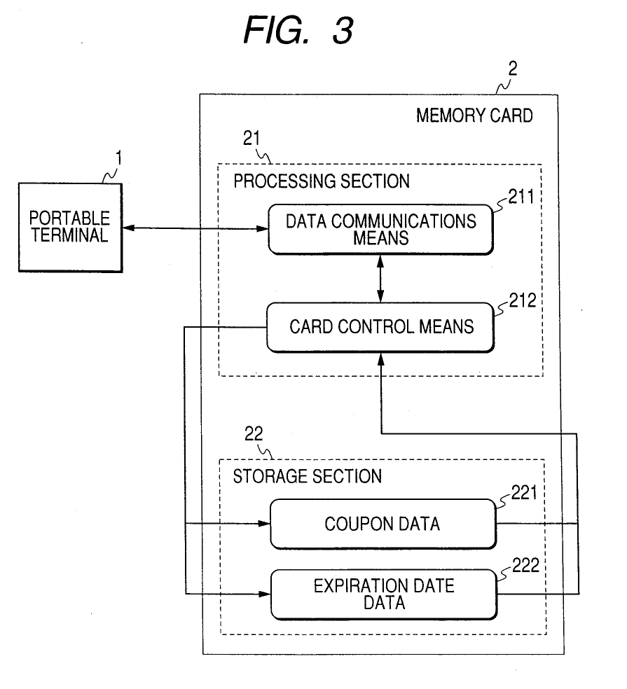

FIG. 3 is a view showing the functional configuration of the memory card according to a first embodiment of the present invention. The processing section 21 of the memory card 2 comprises data communications means 211 for transmitting and receiving data to and from the portable terminal 1; and card control means 212 having the function of change-of-time detection means for detecting that time information has been changed by the portable terminal 1 and the function of control means for determining the update of the data stored in the storage section 22 or the expiration dates of coupons.

The storage section 22 has the function of content storage means and the function of limitation-on-usage information storage means. Coupon data 221 including service details of coupons having expiration dates, expiry information, and the like are stored as contents in the storage section 22. Expiration date data 222, which show expiration dates of coupons, are stored as limitation-on-usage information.

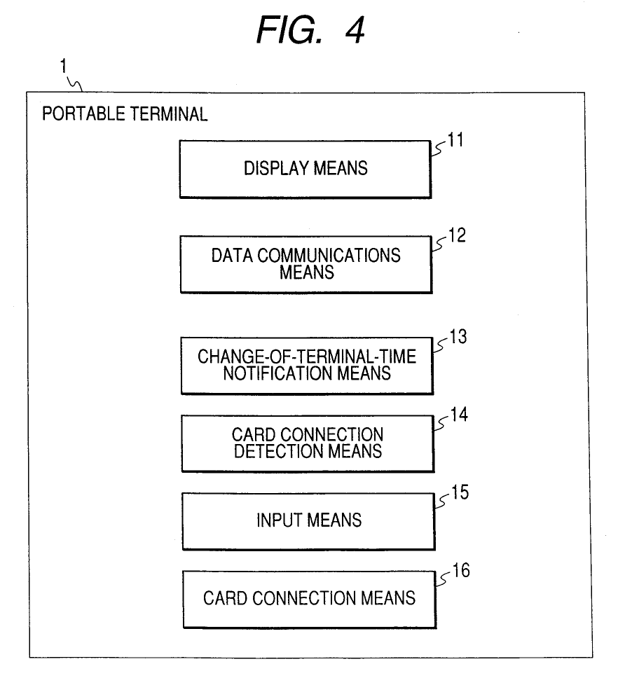

FIG. 4 is a view showing the functional configuration of a portable terminal according to the embodiment of the present invention. The portable terminal 1 comprises display means 11; data communications means 12; terminal time change notification means 13, card connection detection means 14, input means 15, and card connection means 16. The display means 11 is formed from a display device such as a liquid-crystal display device or the like; and displays various operating statuses, details of communication, processing specifics, and the like in the portable terminal 1. The data communications means 12 has a communication section for performing wireless or wired communication and exchanges data with the coupon server 3 and the memory card 2. The input means 15 is formed from a key device for input operation purpose, or the like, and the user inputs data into the portable terminal 1.

The card connection means 16 is formed by comprising a card interface and a connection connector; and connects the memory card 2 to the portable terminal 1 to thus enable exchange of data and supply of power. The terminal time change notification means 13 is implemented by means of a processor or the like in the portable terminal 1; and notifies the memory card 2 that time information such as the clock of the portable terminal 1 has been changed. The card connection detection means 14 is implemented by a sensor, a processor, or the like; and detects whether or not the memory card 2 is newly connected.

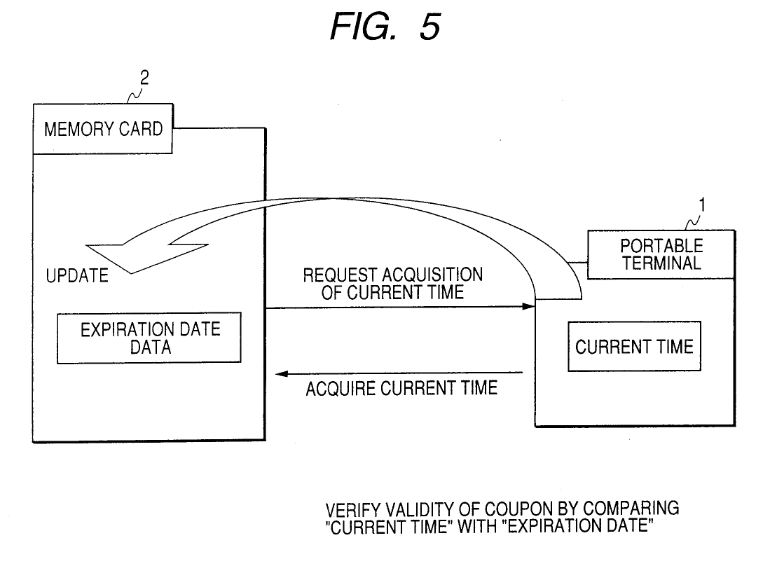

Operations of the individual sections of the first embodiment will now be described. FIG. 5 is a view showing general operation performed for determining the validity of coupon data in the first embodiment. In the first embodiment, the expiration date data 222 are stored in the storage section 22 of the memory card 2 along with coupon data 221. When the memory card 2 has been newly attached to the portable terminal 1 or when the time information pertaining to the portable terminal 1 has been changed, or when the memory card 2 has detected a change-of-time event of the portable terminal 1, the current times of the portable terminal 1 achieved before and after occurrence of the event are acquired, and the expiration date data 222 stored in the memory card 2 are updated in accordance with information about these current times. When the coupon data 221 are used, the current time of the portable terminal 1 is acquired, and the expiration date of the expiration date data 222 and the current time of the portable terminal 1 are compared with each other, to thus determine the validity of coupon data.

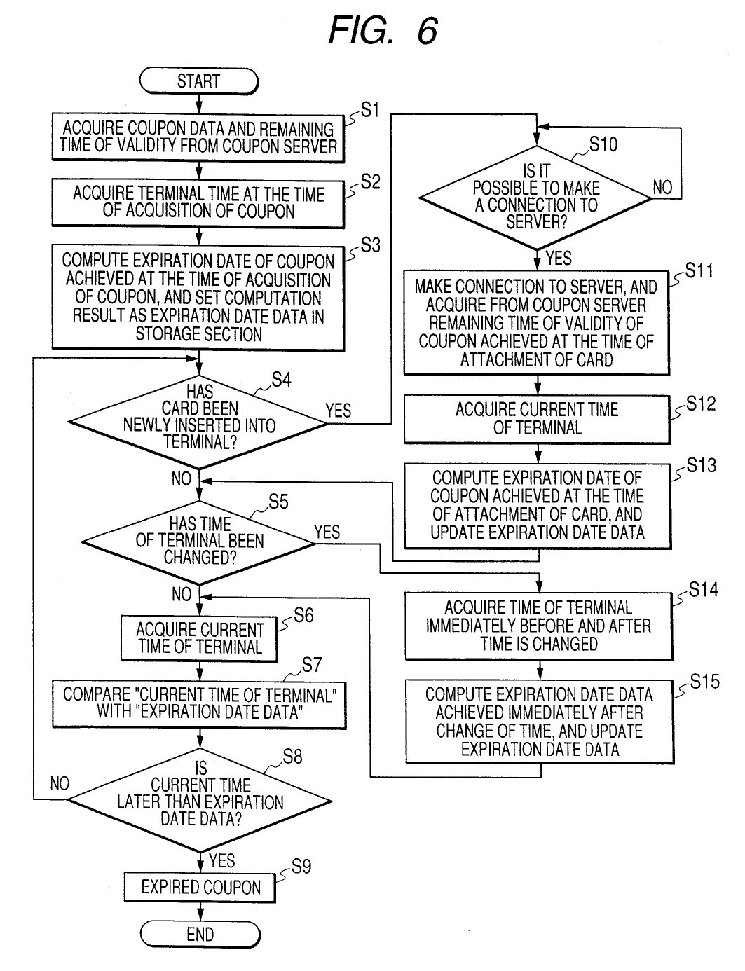

FIG. 6 is a flowchart showing operation procedures of a memory card 2 of the first embodiment. In the memory card 2, the card control means 212 acquires coupon data and the remaining time of validity of the coupon from the coupon server 3 by way of the data communications means 221 (step S1). The card control means 212 acquires the current time of the portable terminal 1, which has been achieved at the time of acquisition of the coupon, as terminal time information by way of the data communications means 211 (step S2). The card control means 212 computes the expiration date of the coupon achieved at the time of acquisition thereof, from the acquired remaining time of validity of the coupon and the current time of the portable terminal 1, and stores the thus-determined expiration date as the expiration date data 222 in the storage section 22 (step S3). Accordingly, the expiration date data 222 based on the current time of the portable terminal 1, which have been achieved at the time of acquisition of the coupon, are set in the memory card 2.

The card control means 212 monitors whether or not the memory card 2 is newly attached to the portable terminal 1 (step S4); and monitors whether or not the time information about the portable terminal 1 has been changed (step S5).

When the memory card 2 is not detected to have been newly attached to the portable terminal 1 (NO in step S4) and the time information about the portable terminal 1 is not detected to have been changed (NO in step S5), the card control means 212 periodically acquires the current time of the portable terminal 1, e.g., once a day, once per hour, or the like (step S6). The current time of the portable terminal 1 is compared with the expiration date data 222 of the coupon stored in the storage section 22 (step S7).

A determination is made as to whether or not the current time of the portable terminal 1 falls after the expiration date data 222 pertaining to the coupon (step S8). When the current time of the portable terminal 1 has passed the expiration date of the coupon, the card control means 212 processes an expired coupon (step S9). Processing of an expired coupon may include processing for causing the card control means 212 to delete the coupon data 221 from the storage section 22; processing for notifying the portable terminal 1 of expiration of the coupon and causing the display means 11 to display a message of expiration of the coupon, or further causing the display means 11 to display a message of an application for extension of the expiration date of the coupon; and the like.

In step S8, when the current time of the portable terminal 1 falls before the expiration date data pertaining to the coupon; namely, when the current time of the portable terminal 1 has not passed the expiration date of the coupon, processing returns to step S4, and processing for detecting attachment of the memory card 2 and processing for detecting a change in the time of the portable terminal 1 are repeated.

In step S4, when attachment of the memory card 2 to the portable terminal 1 has been detected, the card control means 212 attempts to make a connection to the coupon server 3 (step S10). When a connection to the coupon server 3 has failed, an attempt is made to establish a connection to the coupon server 3 at given time intervals. When a connection has been made to the coupon server 3, the remaining time of validity of the coupon achieved at the time of attachment of the current memory card is acquired from the coupon server 3 (step S11).

The card control means 212 acquires the current time of the portable terminal 1 to which the memory card 2 of the card control means is attached (step S12). Subsequently, the remaining time of validity of the coupon achieved at the time of attachment of the memory card to the terminal is added to the acquired current time of the portable terminal 1, to thus compute the expiration date of the coupon achieved at the time of attachment of the memory card; and the expiration date data 222 stored in the storage section 22 are updated by means of the determined expiration date (step S13). Subsequently, processing returns to step S5.

Therefore, by means of processing pertaining to steps S4 and S10 to S13, when the memory card 2 is newly attached to the portable terminal 1, the expiration date data 222 stored in the storage section 22 are updated to the new expiration date data 222 achieved after attachment of the memory card. Therefore, according to processing for determining an expiration date in steps S7, S8, expiration of a coupon or the like is determined on the basis of the new expiration date data 222 acquired after attachment of the memory card.

When in step S5 the change of time has been detected from the change-of-time event of the portable terminal 1, the card control means 212 acquires time information achieved immediately before and after change of the time of the portable terminal 1 (step S14). The remaining time of validity of the coupon up to a point in time immediately before the change of time is computed from a difference between the time information achieved immediately before the change of time and the time information achieved immediately after the change of time in the portable terminal 1. A new expiration date achieved immediately after change of time information is computed, and the expiration date data 222 stored in the storage section 22 are updated by means of the thus-determined expiration date (step S15). Subsequently, processing returns to step S6.

Therefore, when the time information about the portable terminal 1 has been changed by means of processing pertaining to steps S5, S14, and S15, the expiration date data 222 stored in the storage section 22 are updated to new expiration date data 222 achieved after the change of time of the terminal. Through processing pertaining to steps S7, S8 for determining an expiration date, a determination is made as to whether or not the coupon has expired, on the basis of the new expiration date data 222 achieved after the change of time of the terminal.

Operation of the memory card 2 of the first embodiment will now be described by means of taking a specific time as an example.

(1-1) Operation Performed at the Time of Acquisition of a Coupon

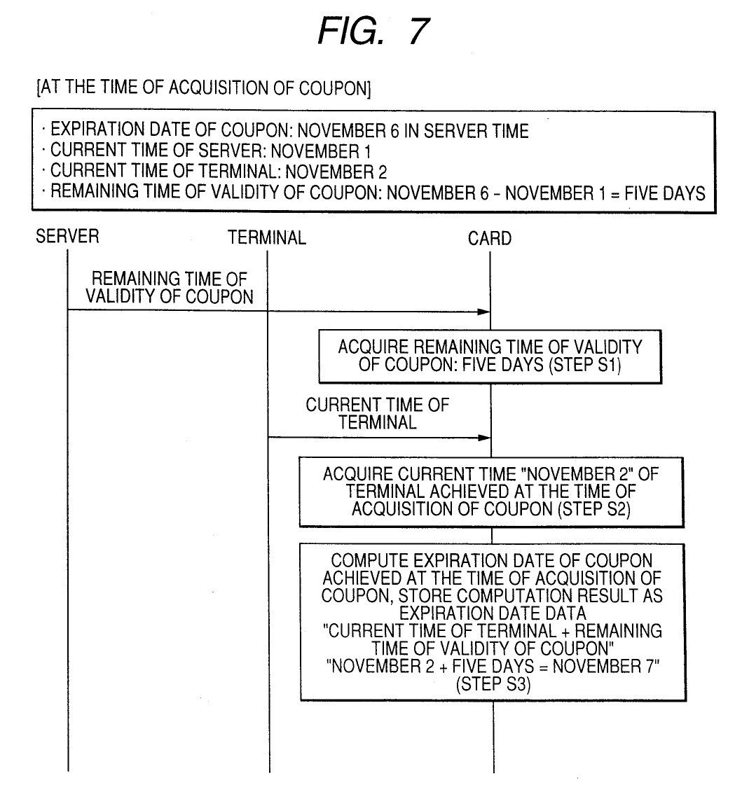

Operation performed at the time of acquisition of a coupon in the first embodiment will now be described. FIG. 7 is a view showing a specific example operation performed at the time of acquisition of a coupon in the first embodiment.

The expiration date of the coupon is presumed to be November 6 in the time of the server; namely, time information about the coupon server 3. Further, the current time of the coupon server 3 is presumed to be November 1; the time information about the current time of the portable terminal 1 achieved at the time of acquisition of a coupon is presumed to be November 2; and the remaining time of validity of the coupon is presumed to be November 6−November 1=five days. For convenience of description, each of the specific examples of the times is assumed to include the month and date. However, it is assumed that the times can be set up to hours, minutes, and seconds.

By means of processing pertaining to step S1 in FIG. 6, the card control means 212 of the memory card 2 acquires a coupon and the remaining time of validity of the coupon; i.e., five days, from the coupon server 3 by way of the data communications means 211. The thus-acquired information about the coupon is stored as coupon data 221 in the storage section 22.

By means of processing pertaining to step S2 shown in FIG. 6, the card control means 212 acquires current time information “November 2” about the portable terminal 1 from the portable terminal 1 by way of the data communications means 211; and computes the expiration date of the coupon achieved at the time of acquisition thereof through processing pertaining to step S3 shown in FIG. 6. Specifically, there is performed computation; namely, “current time of the portable terminal 1+the remaining time of validity of a coupon”; namely, “November 2+five days=November 7” in the case of the previously-described conditions. The thus-determined November 7 is stored in the storage section 22 as the expiration date data 222.

(1-2) Operation Performed when a Coupon is Determined to be Invalid

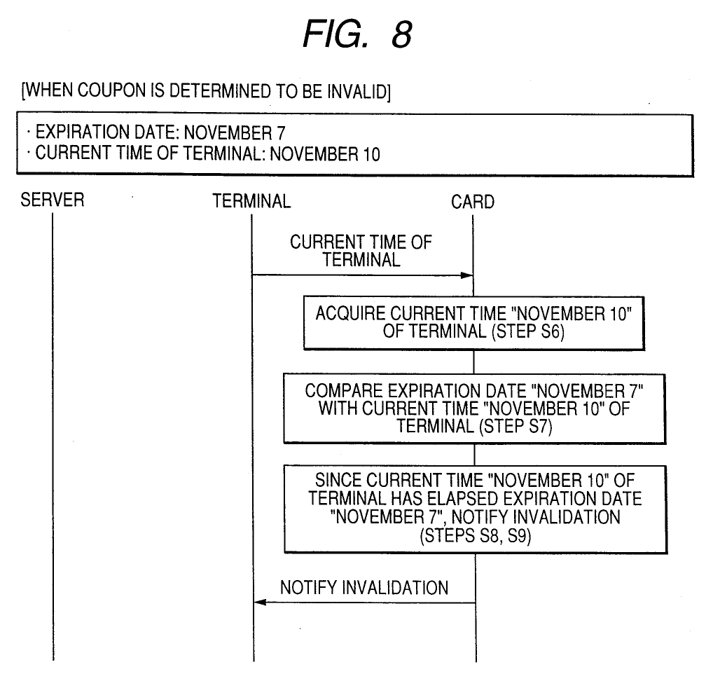

Next, operation performed when a coupon is determined to be invalid will be described as an example of a determination of the expiration date of a coupon in the first embodiment. FIG. 8 is a view showing a specific operation example performed when a coupon is determined to be invalid in the first embodiment. The expiration date of a coupon is assumed to be November 7; and the information about the current time of the portable terminal 1 is assumed to be November 10.

Through processing pertaining to step S6 shown in FIG. 6, the card control means 212 of the memory card 2 acquires November 10 as information about the current time of the portable terminal 1, from the portable terminal 1 by way of the data communications means 211. Through processing pertaining to step S7 shown in FIG. 6, the card control means 212 compares an expiration date of November 7 of the coupon, which is determined by the expiration date data 222 stored in the storage section 22, with the thus-acquired time information of November 10 of the portable terminal 1.

In the case of this embodiment, a current time of November 10 of the portable terminal 1 has passed an expiration date of November 7 of the coupon. Accordingly, YES is selected through determination processing pertaining to step S8 in FIG. 6. Through processing pertaining to step S9 in FIG. 6, processing of expiration of a coupon is performed. For instance, expiration of a coupon is notified to the portable terminal 1, and an expiration message to the effect that the coupon is invalid is displayed on the display means 11, and invalidity is notified to the user.

(1-3) Operation Performed when a Coupon is Determined to be Valid

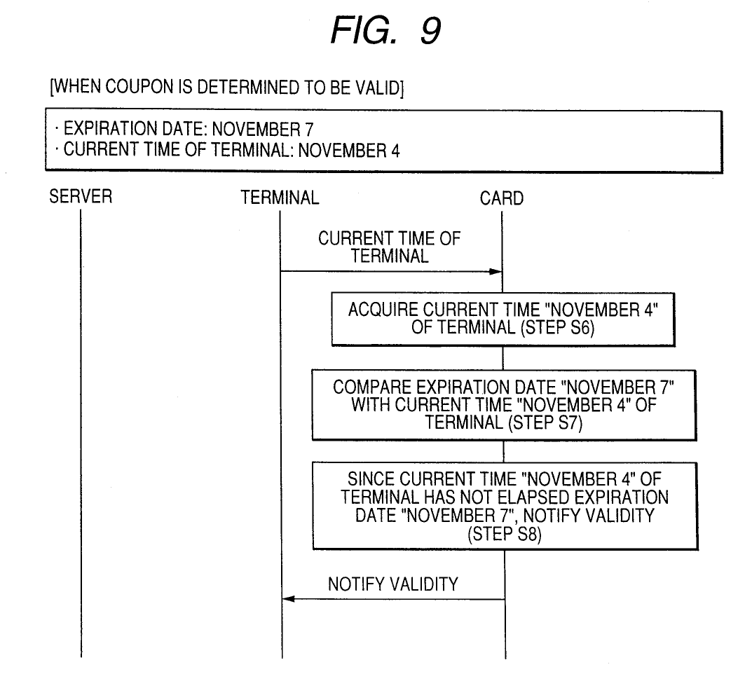

Operation performed when a coupon is determined to be valid will now be described as another example of determination about an expiration date of a coupon in the first embodiment. FIG. 9 is a view showing a specific operation example performed when the validity of the coupon is determined in the first embodiment. The expiration date of the coupon is presumed to be November 7, and information about the current time of the portable terminal 1 is presumed to be November 4.

Through processing pertaining to step S6 in FIG. 6, the card control means 212 of the memory card 2 acquires, from the portable terminal 1, November 4 as information about the current time of the portable terminal 1, by way of the data communications means 211. Through processing pertaining to step S7 in FIG. 6, the card control means 212 compares an expiration date of November 7 of the coupon, which is determined on the basis of the expiration date data 222 stored in the storage section 22, with acquired time information November 4 of the portable terminal 1.

In the case of this embodiment, a current time of November 4 of the portable terminal 1 has not passed an expiration date of November 7 of the coupon. Hence, NO is selected through determination processing pertaining to step S8 in FIG. 6, and the current coupon is determined to be valid, and processing returns to processing pertaining to step S4. In this case, the portable terminal 1 may be notified that the coupon is valid, and a message to the effect that the coupon is valid, such as validity, may be displayed on the display means 11, to thus notify the user of validity.

(1-4) Operation Performed at the Time of the Change of Terminal Time

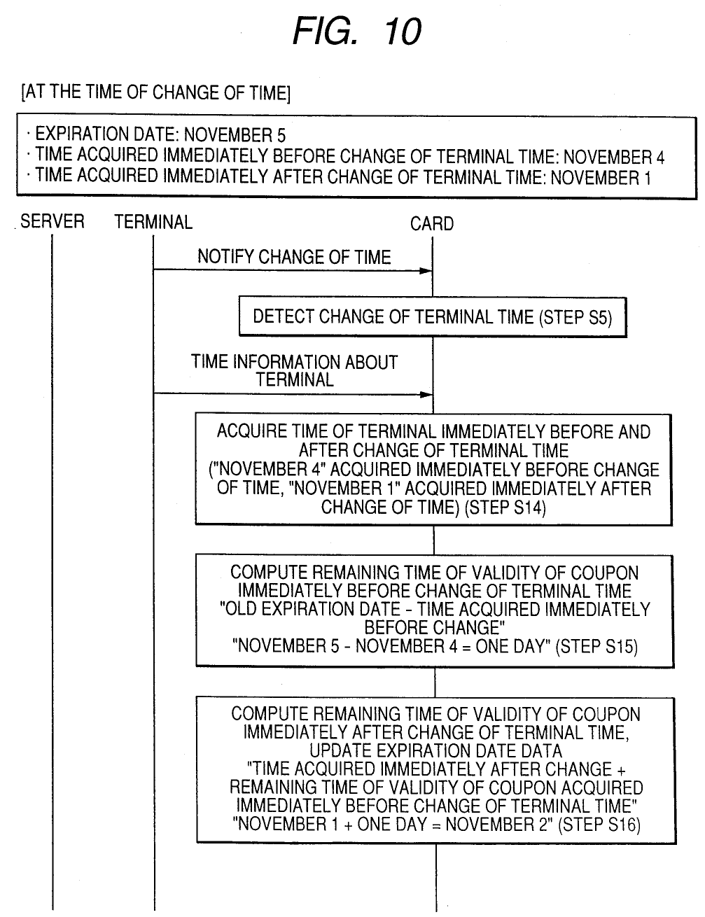

Next, operation performed at the time of the change of terminal time in the first embodiment will be described. FIG. 10 is a view showing a specific example operation performed when the time of a terminal is changed in the first embodiment. The expiration date of a coupon is presumed to be November 5; the time achieved immediately before change of time of the portable terminal 1 is presumed to be November 4; and the time achieved immediately after change of time of the portable terminal 1 is presumed to be November 1.

When the time information has been changed by the portable terminal 1 by means of user's operation or the like, the terminal time change notification means 13 of the portable terminal 1 detects the event and notifies the data communications means 211 of the memory card 2 of the change of time of the terminal. At this time, when the memory card 2 has received the notification of the change of time of the terminal, the card control means 212 detects the change-of-time event in the portable terminal 1 by means of determination processing pertaining to step S5 in FIG. 6. By means of processing pertaining to step S14 in FIG. 6, a time of November 4 achieved immediately before the change of time of the portable terminal 1 and a time of November 1 achieved immediately after the change of time are acquired by way of the data communications means 211.

Next, through processing pertaining to step S15 in FIG. 6, the card control means 212 computes the remaining time of validity of the coupon achieved immediately before the change of time of the portable terminal 1. Specifically, the remaining time of validity of a coupon achieved before immediately before the change of time is computed by means of an expression of “old expiration date−time achieved immediately before change of time”; namely, “November 5−November 4=one day.” An expiration date achieved immediately before the change of time is computed from the remaining time of validity achieved immediately after the change, and the expiration date data are updated by means of taking the result of computation as a new expiration date. Specifically, there is performed computation of “time of the terminal achieved immediately after the change+the remaining time of validity of the coupon achieved immediately before the change of time”; namely, “November 1+one day=November 2,” and the thus-determined November 2 is taken as new expiration date data 222 to thus update the expiration date data.

Therefore, when the time information about the portable terminal 1 has been changed, the memory card 2 updates, in accordance with the change of the time, the expiration date data 222 stored in the storage section 22 to new expiration date data 222 achieved after the change of the time of the terminal. A determination is made as to whether or not the coupon has expired, on the basis of the new expiration date data 222.

(1-5) Operation Performed at the Time of Attachment of the Card

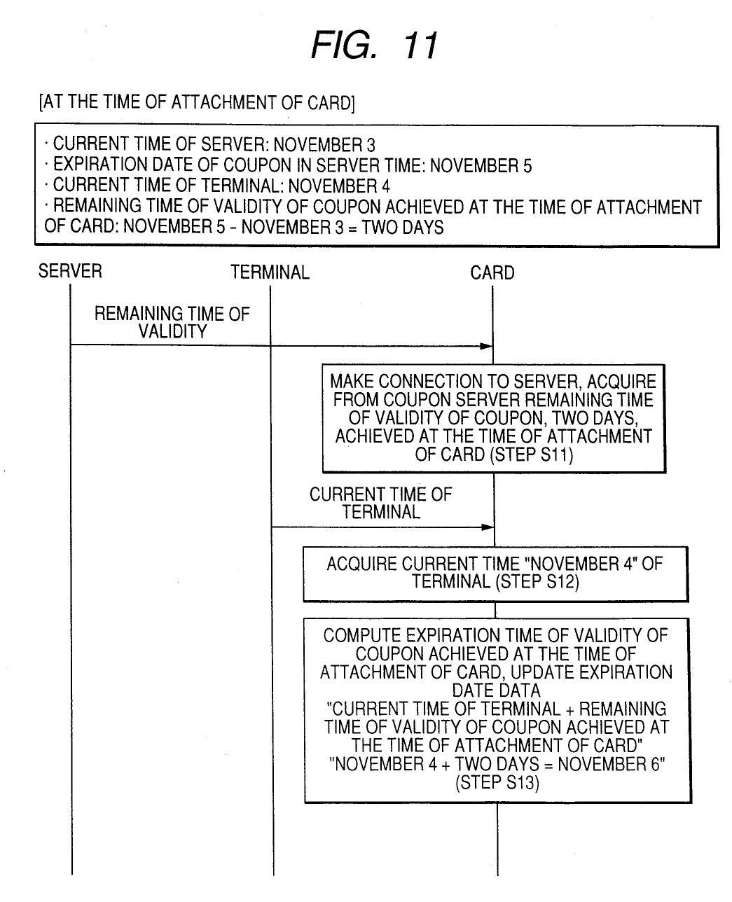

Next, operation performed at the time of attachment of the card in the first embodiment will be described. FIG. 11 is a view showing a specific example operation performed at the time of attachment of a card in the first embodiment. The current time of the coupon server 3 is presumed to be November 3; the expiration date of the coupon achieved in the server time of the coupon server 3 is presumed to be November 5; and the current time of the portable terminal 1 is presumed to be November 4. The remaining time of validity of the coupon achieved at the time of attachment of the memory card 2 to the portable terminal 1 is presumed to be November 5−November 3=two days.

When the memory card 2 is connected to a card slot, or the like, of the portable terminal 1, the card connection detection means 14 of the portable terminal 1 notifies the data communications means 211 of the memory card 2 of connection of the card. At this time, when the memory card 2 has received the card connection notification, the card control means 212 detects an event of connection of the card to the portable terminal 1 through determination processing pertaining to step S4 in FIG. 6. By means of processing pertaining to step S10 in FIG. 6, the data communications means 211 makes a connection to the coupon server 3, and a remaining time of validity of the coupon; that is, two days, achieved at the time of attachment of the memory card, is acquired from the coupon server 3 by means of subsequent processing pertaining to step S11 in FIG. 6.

Through processing pertaining to step S12 in FIG. 6, the data communications means 211 acquires from the portable terminal 1 information about the current time thereof; i.e., November 4. The card control means 212 computes a new expiration date of the coupon achieved at the time of attachment of the card, through processing pertaining to step S13 in FIG. 6. Specifically, there is performed computation of “current time of the portable terminal 1+the remaining time of validity of a coupon achieved at the time of attachment of a card”; namely, “November 4+two days=November 6.” The thus-determined expiration date, November 6, is taken as new expiration date data 222, and the expiration date data 222 in the storage section 22 are updated.

Therefore, when the memory card 2 having a coupon stored therein is newly attached to the portable terminal 1; when the memory card 2 is re-attached to the portable terminal 1 after having once been removed from the same; or when the memory card 2 which has been removed from another portable terminal 1 is attached, the expiration date data 222 stored in the storage section 22 are updated, in the memory card 2, to new expiration date data 222 achieved after attachment of the memory card, by means of the remaining time of validity acquired from the coupon server 3 and the current time of the portable terminal 1. On the basis of the new expiration date data 222, a determination is made as to whether or not the coupon has expired.

(1-6) Operation Performed at the Time of Acquisition of Expiration Date Information about a Coupon

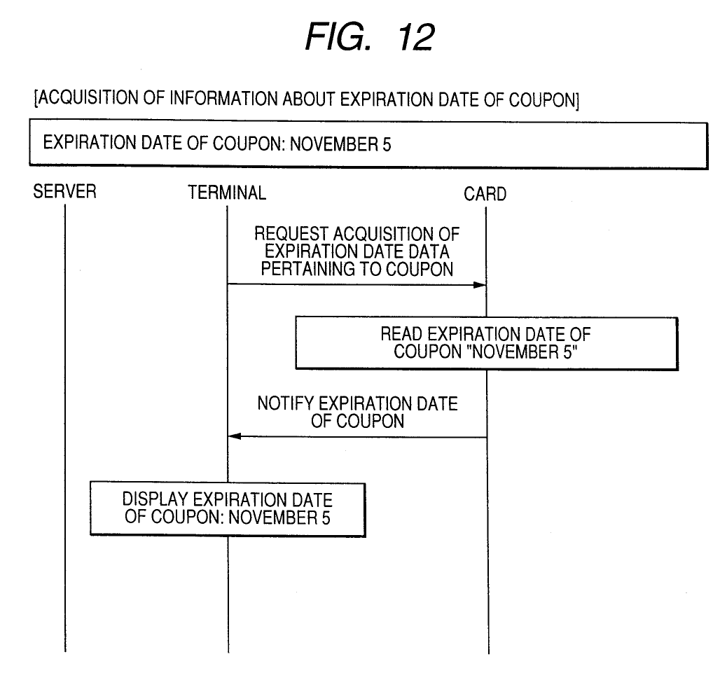

Operation to be performed at the time of acquisition of expiration date information about a coupon in the first embodiment will now be described. FIG. 12 is a view showing a specific example operation performed at the time of acquisition of expiration date information about the coupon in the first embodiment. The expiration date of a coupon is presumed to be November 5.

The user performs operation for requesting acquisition of expiration date information about a coupon, by use of the input means 15 of the portable terminal 1. Upon receipt of the request entered by means of the input operation of the user, the portable terminal 1 sends the request for acquisition of expiration date data pertaining to a coupon to the memory card 2 by the data communications means 12. In the memory card 2, when the data communications means 211 has received the request for acquisition of expiration date data pertaining to a coupon, the card control means 212 detects the event; reads the expiration date data, November 5, stored in the storage section 22; and transmits the expiration date data to the portable terminal 1 by the data communications means 211, to thus notify the expiration date of the coupon.

When the data communications means 12 has received the expiration date data pertaining to a coupon responding to the request from the user, the portable terminal 1 displays the expiration data information on the display means 11. Thereby, the user is notified that the expiration date of the coupon is November 5.

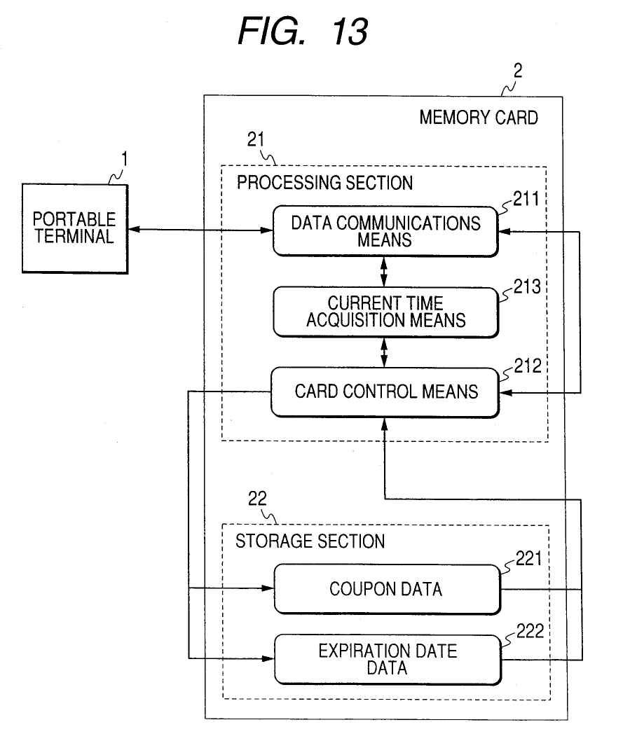

The memory card 2 may also adopt, as a first modification of the first embodiment, a configuration of acquiring a current time from the portable terminal 1 in a more independent manner than does the medium. FIG. 13 is a view showing the functional configuration of the memory card according to a first modification of the first embodiment. In this first modification, the processing section 21 of the memory card 2 has current time acquisition means 213 for independently acquiring the current time of the portable terminal 1. In other respects, the present configuration is analogous to that of the first embodiment shown in FIG. 3. Thus, even when the current time acquisition means 213 is provided, a function analogous to that described in connection with the first embodiment can be acquired.

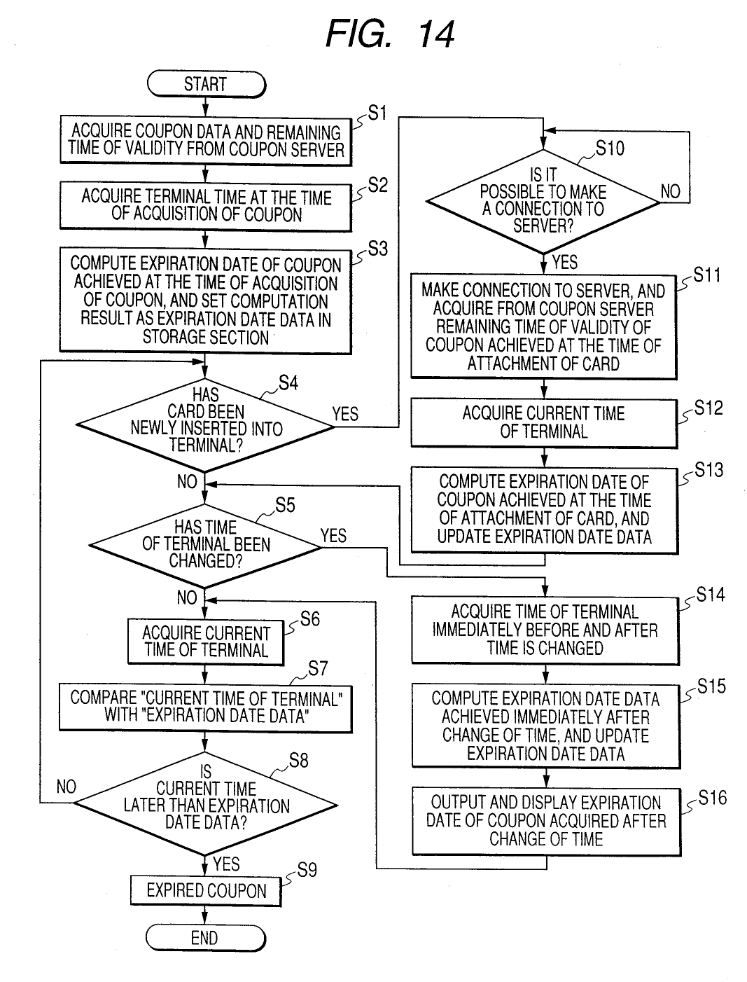

The expiration date, which has been acquired after change of time of the terminal, may be displayed on the portable terminal 1 as a second modification of the first embodiment. FIG. 14 is a flowchart showing operation procedures of the memory card according to a second modification of the first embodiment. In the second modification, when the time information about the portable terminal 1 has been changed through processing pertaining to steps S5, and S14 to S15, the expiration date data 222 stored in the storage section 22 are updated to new expiration date data 222 achieved after the change of time of the terminal; the updated expiration date data 222 pertaining to a coupon are output and transmitted to the portable terminal 1; and the thus-transmitted expiration date data 222 are displayed on the display means 11 of the portable terminal 1 (step S16). In other respects, the operation of the second modification is the same as that described in connection with the first embodiment shown in FIG. 6. Thus, an expiration date achieved after the change of time of the terminal is displayed on the portable terminal 1, so that the user can ascertain the expiration date achieved when the time of the terminal has been changed.

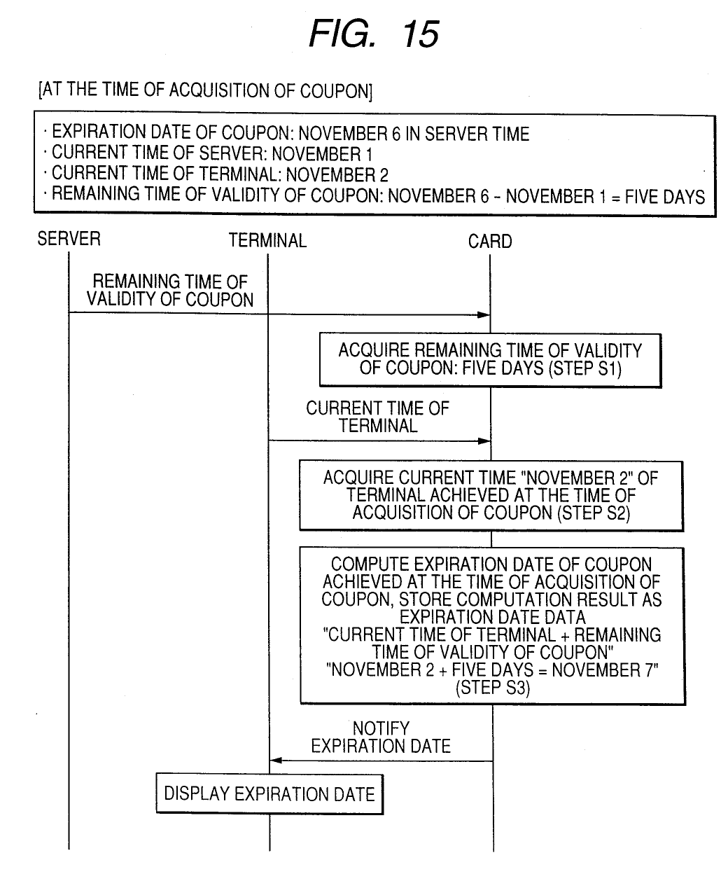

The expiration date may be displayed on the portable terminal 1 at the time of acquisition of a coupon, as a third modification of the first embodiment. FIG. 15 is a view showing a specific example operation performed at the time of acquisition of a coupon in the third modification of the first embodiment. In the third modification, the card control means 212 acquires a coupon from the coupon server 3 and the remaining time of validity of the coupon; namely, “five days.” The current time information about the terminal; namely, “November 2,” is acquired from the portable terminal 1, and the expiration date of the coupon achieved at the time of acquisition of the coupon is computed. Specifically, there is computed “current time of the portable terminal 1+the remaining time of validity of a coupon.” Under the previously-described conditions, “November 2+five days=November 7” is computed. The thus-determined November 7 is stored as the expiration date data 222 in the storage section 22. November 7 is transmitted as the expiration date data 222 to the portable terminal 1 by the data communications means 211, thereby notifying the expiration date of the coupon. The portable terminal 1 having received the notification displays November 7 as the expiration date of the coupon on the display means 11, thereby notifying the user of the expiration date. In other respects, the operation of the third modification is identical with that of the first embodiment shown in FIG. 7. Hence, the expiration date achieved at the time of acquisition of a coupon is displayed on the portable terminal 1, whereby the user can ascertain the acquired expiration date.

Although the descriptions of the first embodiment have illustrated the memory card 2 that can be removably attached to the portable terminal 1, the function included in the memory card 2 can also be applied in the same way to built-in, unremovable memory of the portable terminal 1, such as an IC chip. In such a case, among the procedures shown in FIG. 6, processing pertaining to the case where the memory card 2 is attached to the portable terminal 1 becomes unnecessary (steps S4 and S10 to S13).

In connection with the procedures shown in FIG. 6, processing being performed at the time of attachment of the card, which pertains to steps S4 and S10 to S13, and processing when the time of the terminal is changed, which pertains to steps S5, S14, and 15, may be reversed in sequence.

The processing section 21 of the memory card 2 can also be configured in the form of software by means of a processor and a program which runs on the processor. Alternatively, the processing section 21 can also be configured in the form of hardware by means of a circuit having the custom-designed processing function.

Access is made to the coupon server 3 at a predetermined cycle; e.g., once a day, once a week, or the like, as well as when the memory card 2 is attached to the portable terminal 1. As in the case with the procedures pertaining to steps S10 to S13 shown in FIG. 6, the remaining time of validity of the coupon is acquired from the coupon server 3, and the current time is acquired from the portable terminal 1. The latest expiration date is computed from these pieces of information, and the expiration date data 222 can also be updated. Even when the clock of the coupon server 3 and the clock of the portable terminal 1 are not synchronized with each other and when the difference between the pieces of time information about the clocks naturally increases, the expiration date data 222 can be maintained properly, and the expiration date can be accurately determined at all times.

As mentioned above, in the first embodiment, even when the time information about the portable terminal 1 has been changed, the memory card 2 detects the change-of-time event, and the expiration date data 222 pertaining to the coupon are updated on the basis of the pieces of time information achieved before and after the change of time of the portable terminal 1. The expiration date matching the current time of the portable terminal 1, which uses the coupon, is maintained at all times in the memory card 2. The expiration date and the current time of the portable terminal 1 are compared with each other, so that the expiration date of the coupon can be accurately determined at all times. When the memory card 2 is attached to the portable terminal 1, the expiration date data 222 pertaining to the coupon can be updated in accordance with the time information from the coupon server 3 and the time information about the portable terminal 1.

Consequently, for instance, even when the user of the portable terminal 1 has changed the time information about the portable terminal 1, access is not made to the coupon server 3 each time. The expiration data can be correctly updated by means of only the portable terminal 1, and the expiration date of the current coupon can be accurately grasped and determined. Thus, unauthorized use of a coupon; for instance, the change of time information about the portable terminal 1 intended for using an expired coupon, or the like, can be prevented without making access to the coupon server 3 for checking purpose.

### Second Embodiment

A second embodiment describes another example configuration of the memory card. The memory card 2 of the second embodiment differs from the memory card 2 of the first embodiment in terms of the data stored in the storage section 22. In other respects, the system of the present embodiment is identical in configuration with that of the first embodiment. Therefore, a new reference numeral is assigned solely to the different stored data, and its explanation is provided.

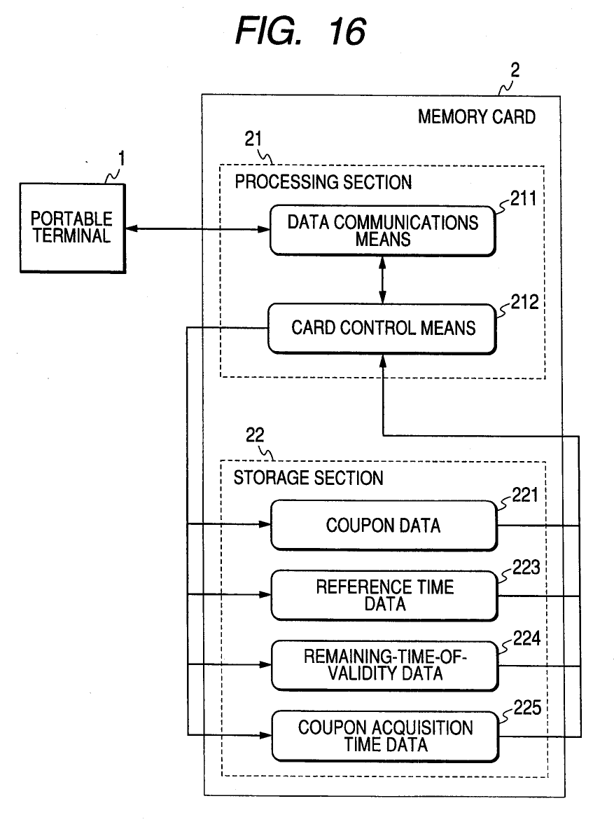

FIG. 16 is a view showing the functional configuration of the memory card according to the second embodiment of the present invention. As with the first embodiment, the memory card 2 has the processing section 21, which includes the data communications means 211 and the card control means 212, and the storage section 22. The storage section 22 has the function of the content storage means and the function of the limitation-on-usage information storage means. Coupon data 221, which are analogous to those of the first embodiment and include service details of a coupon having an expiration date, expiration information, and the like, are stored as contents. Reference time data 223 used for determining the expiration date of a coupon, or the like, remaining-time-of-validity data 224 showing a remaining time of validity of a coupon, coupon acquisition time data 225 corresponding to time information about the coupon server 3 achieved at the time of acquisition of a coupon, and the like, are stored as limitation-on-usage information.

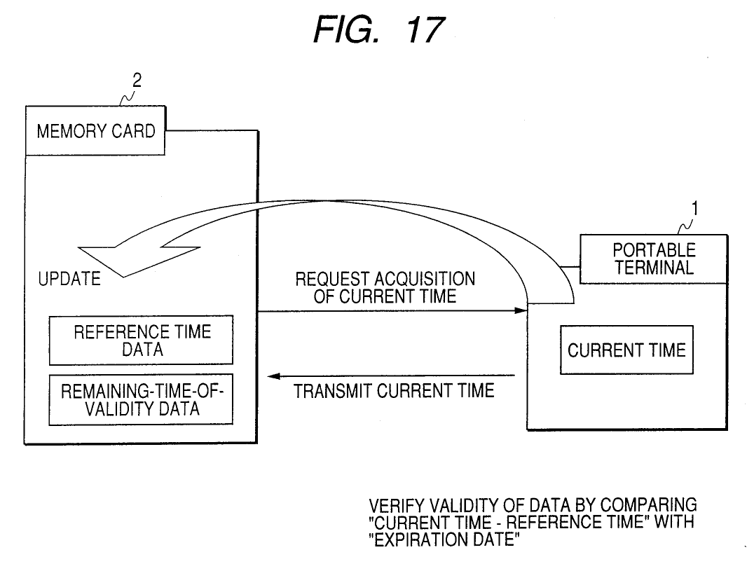

Operations of the individual sections of the second embodiment will now be described. FIG. 17 is a view showing general operation performed for determining the validity of coupon data in the second embodiment. In the second embodiment, the reference time data 223, the remaining-time-of-validity data 224, and the coupon acquisition time data 225 are stored in the storage section 22 of the memory card 2 along with coupon data 221. When the memory card 2 has been newly attached to the portable terminal 1 or when the time information pertaining to the portable terminal 1 has been changed; namely, when the memory card 2 has detected a change-of-time event of the portable terminal 1, the current times of the portable terminal 1 achieved before and after occurrence of the event are acquired. On the basis of information about these current times and the reference time data 223 stored in the memory card 2, the remaining time of validity of data 224 and the reference time data 223 are updated. When the coupon data 221 are used, the current time of the portable terminal 1 is acquired, and a time during which the coupon has been utilized is computed from the current time of the portable terminal 1 and the reference time data 223. The time during which the coupon has been utilized is compared with the remaining-time-of-validity data 224, to thus determine the validity of coupon data.

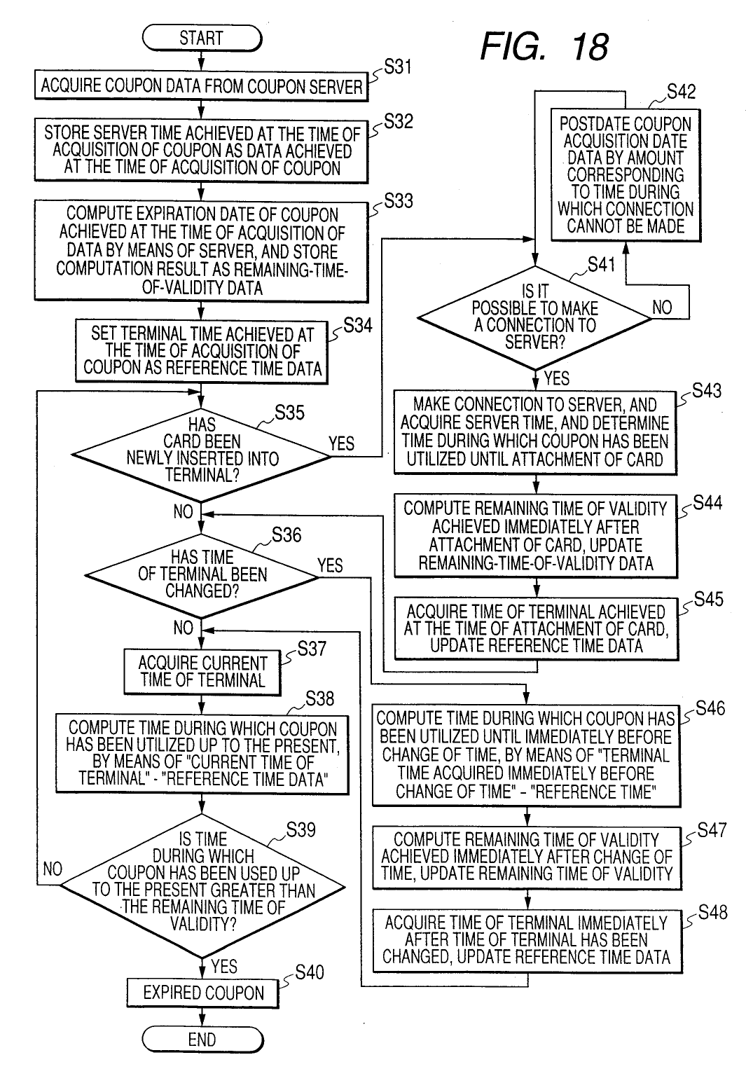

FIG. 18 is a flowchart showing operation procedures of a memory card 2 of the second embodiment. In the memory card 2, the card control means 212 acquires coupon data from the coupon server 3 by way of the data communications means 221 (step S31). The card control means 212 acquires a server time, which is information about the time of the coupon server 3 achieved at the time of acquisition of a coupon, from the coupon server 3 by way of the data communications means 211; and stores the server time as coupon acquisition time data 225 in the storage section 22 (step S32). The expiration date achieved at the time of acquisition of a coupon, which has been computed by the coupon server 3, is acquired from the coupon server 3 by way of the data communications means 211. Information about this expiration date is stored in the storage section 22 as the remaining-time-of-validity data 224 achieved at the time of acquisition of a coupon (step S33).

The card control means 212 acquires the current time of the portable terminal 1 achieved at the time of acquisition of a coupon as terminal time information by way of the data communications means 211, and stores the terminal time information as the reference time data 223 into the storage section 22 (step S34).

The card control means 212 monitors whether or not the memory card 2 is newly attached to the portable terminal 1 (step S35); and monitors whether or not the time information about the portable terminal 1 has been changed (step S36).

When the memory card 2 is not detected to have been newly attached to the portable terminal 1 (NO in step S35) and the time information about the portable terminal 1 is not detected to have been changed (NO in step S36), the card control means 212 periodically acquires the current time of the portable terminal 1, e.g., once a day, once per hour, or the like (step S37). The reference time data 223 are subtracted from the current time of the portable terminal 1, to thus compute the time during which the coupon has been utilized up to the present (step S38).

Subsequently, the card control means 212 determines whether or not the determined time during which the coupon has been utilized up to the present is greater than the remaining-time-of-validity data 224; namely, the remaining time of validity of the coupon (step S39). When the time during which the coupon has been utilized up to the present is greater than the remaining-time-of-validity data 224, the card control means 212 determines that the coupon has expired, and performs expiration-of-coupon processing (step S40). When the time during which the coupon has been utilized up to the present is determined, in step S39, to be less than the remaining-time-of-validity data 224, the card control means 212 determines that the coupon has not expired, and returns to previously-described processing pertaining to step S35, where processing, such as detection of attachment of the memory card 2 and detection of the change of time of the portable terminal 1, is iterated.

When attachment of the memory card 2 to the portable terminal 1 has been detected in step S35, the card control means 212 attempts to make a connection to the coupon server 3 (step S41). When a connection cannot be made to the coupon server 3, the coupon acquisition time data 225 stored in the storage section 22 is delayed by an amount corresponding to a period of time during which a connection cannot be made to the coupon server 3 (step S42).

When a connection can be made to the coupon server 3 as a result of attempts having been made at every given time to establish a connection with the coupon server 3, the current time is acquired from the coupon server 3, and the time during which the coupon has been utilized until attachment of the memory card is computed (step S43). The time during which the coupon has been utilized is determined by subtracting the value of the coupon acquisition time data 225 stored in the storage section 22 from the current time of the coupon server 3. The card control means 212 computes the remaining time of validity achieved immediately after attachment of the memory card 2, and updates the remaining-time-of-validity data 224 stored in the storage section 22 by the thus-determined remaining time of validity (step S44). The remaining time of validity is determined by subtracting the time, during which the coupon has been utilized until attachment of the memory card, from the value of the remaining-time-of-validity data 224 stored in the storage section 22 until attachment of the card.

The card control means 212 acquires the current time of the portable terminal 1 achieved at the time of acquisition of the server time in step S43. The thus-acquired current time is taken as the time of the terminal achieved at the time of attachment of the card, and the reference time data 223 stored in the storage section 22 are updated by the time of the terminal (step S45). Subsequently, processing returns to previously-described step S36.

When the memory card 2 is newly attached to the portable terminal 1, the reference time data 223 and the remaining-time-of-validity data 224, both being stored in the storage section 22, are updated to new reference time data 223 and new remaining-time-of-validity data 224, which are achieved after attachment of the memory card, through processing pertaining to steps S35 and S41 to S45. Therefore, through processing for determining the time of validity in steps S38 and S39, a determination is made as to whether or not the coupon has expired, on the basis of the new reference time data 223 and the new remaining-time-of-validity data 224, which are achieved after attachment of the memory card.

When it is detected in step S36 that the time has been changed by the change-of-time event of the portable terminal 1, the card control means 212 acquires the time of the terminal achieved immediately before the time of the portable terminal 1 has been changed. The value of the reference time data 223 stored in the storage section 22 is subtracted from the time of the terminal achieved immediately before the change of time, thereby computing the time during which the coupon has been utilized immediately before the change of time (step S46).

The card control means 212 subtracts the time during which the coupon has been utilized immediately before the change of time determined in step S46 from the value of the remaining-time-of-validity data 224 stored in the storage section 22 immediately before the change of time, to thus determine the remaining-time-of-validity achieved immediately after the change of time. The remaining-time-of-validity data 224 stored in the storage section 22 are updated by the thus-determined remaining time of validity obtained immediately after the change of time (step S47). Moreover, the time of the portable terminal 1 immediately after the change of time is acquired, and the reference time data 223 stored in the storage section 22 are updated by means of the thus-acquired time of the terminal obtained immediately after the change of time (step S48). Subsequently, processing returns to previously-described step S37.

Accordingly, when information about the time of the portable terminal 1 has been changed through processing pertaining to steps S36 and S46 to S48, the reference time data 223 and the remaining-time-of-validity data 224, which are stored in the storage section 22, are updated to new reference time data 223 and remaining-time-of-validity data 224 achieved after the change of time of the terminal. Therefore, through processing for determining the expiration data in steps S38 and S39, expiration of a coupon or the like is determined on the basis of the new reference time data 223 and the remaining-time-of-validity data 224, which are acquired after the change of time of the terminal.

Operation of the memory card 2 of the second embodiment will now be described by means of taking specific times as an example.

(2-1) Operation Performed at the Time of Acquisition of a Coupon

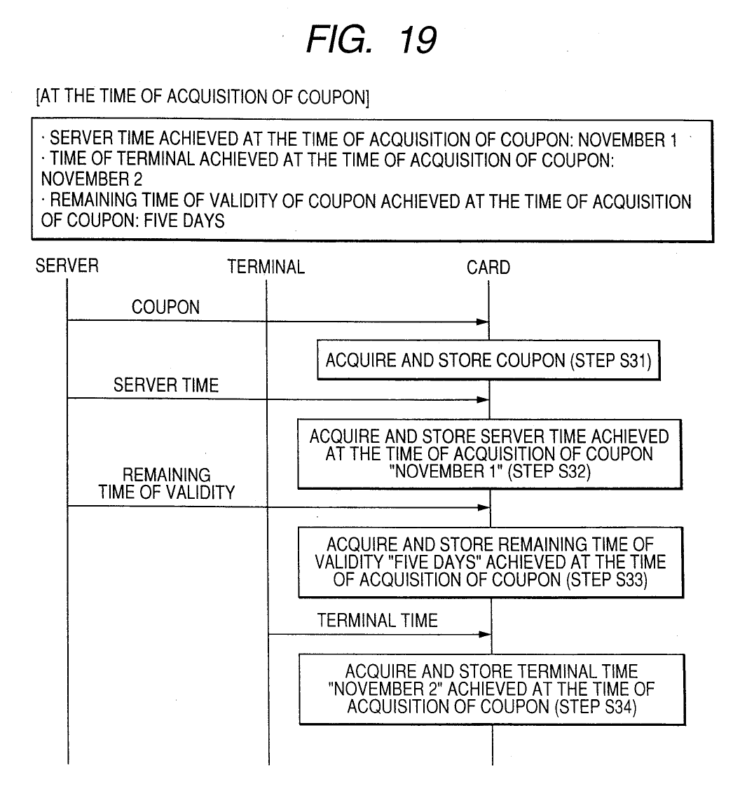

Operation performed at the time of acquisition of a coupon in the second embodiment will now be described. FIG. 19 is a view showing a specific example operation performed at the time of acquisition of a coupon in the second embodiment.

The time of the coupon server 3 achieved at the time of acquisition of a coupon is presumed to be November 1, and the time of the portable terminal 1 achieved at the time of acquisition of a coupon is presumed to be November 2. Further, the remaining time of validity of the coupon is presumed to be a result of November 6−November 1, i.e., five days, by means of subtracting the time of the server achieved at the time of acquisition of the coupon from the expiration date of the coupon in the server time of the coupon server 3; e.g., November 6.

The card control means 212 of the memory card 2 acquires a coupon from the coupon server 3 by way of the data communications means 211 through processing pertaining to step S31 shown in FIG. 18, and stores information about the thus-acquired coupon into the storage section 22 as coupon data 221. Concurrently, the card control means 212 acquires a server time of “November 1,” achieved at the time of acquisition of the coupon, from the coupon server 3 by way of the data communications means 211 through processing pertaining to S32 shown in FIG. 18; and stores the server time in the storage section 22 as coupon acquisition time data 225.

Through processing pertaining to step S33 in FIG. 18, the card control means 212 acquires from the coupon server 3 a remaining time of validity of the coupon, “five days,” achieved at the time of acquisition of a coupon by way of the data communications means 211; and stores the remaining-time-of-validity data 224 into the storage section 22. Further, through processing pertaining to step S34 in FIG. 18, the card control means 212 acquires from the portable terminal 1 the terminal time of November 2 achieved at the acquisition of a coupon by way of the data communications means 211, to thus store the reference time data 223 into the storage section 22.

(2-2) Operation Performed when a Coupon is Determined to be Invalid

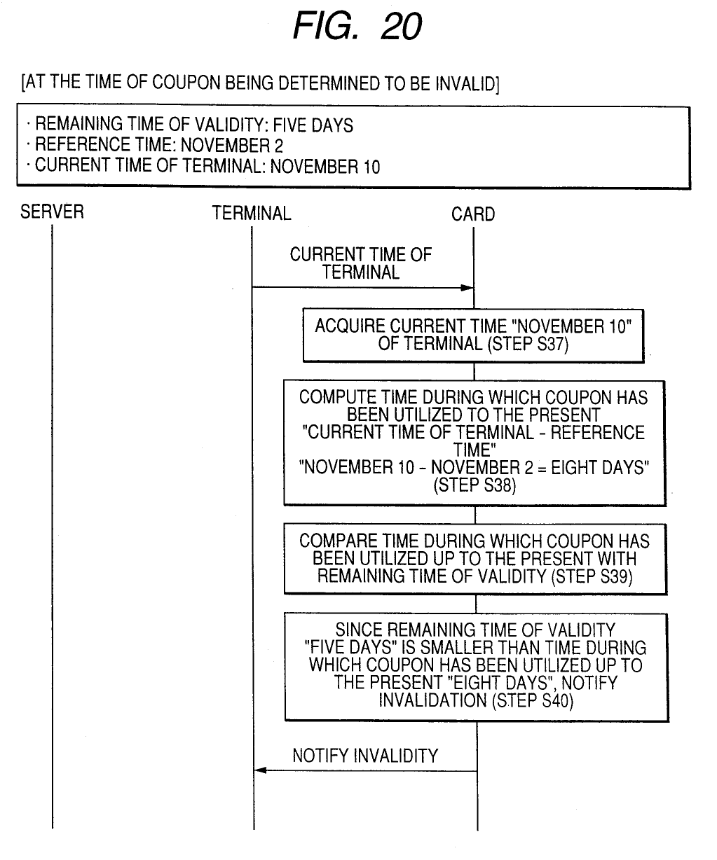

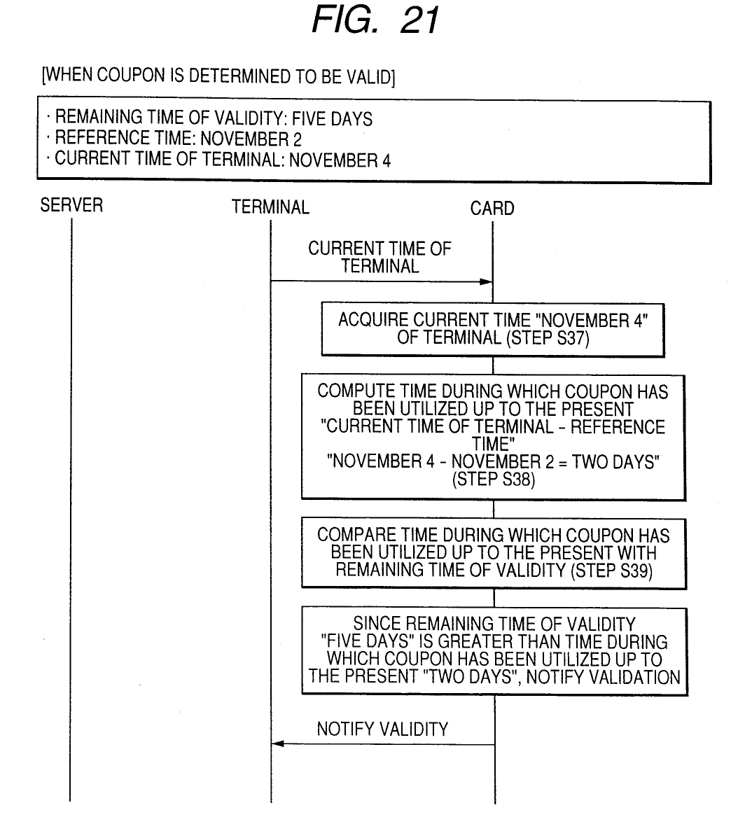

Next, operation performed when a coupon is determined to be invalid will be described as an example of a determination of the expiration date of a coupon in the second embodiment. FIG. 20 is a view showing a specific operation example performed when a coupon is determined to be invalid in the second embodiment. The remaining time of validity of the coupon is presumed to be five days; the reference time is assumed to be November 2; and the information about the current time of the portable terminal 1 is assumed to be November 10.

Through processing pertaining to step S37 shown in FIG. 18, the card control means 212 of the memory card 2 acquires November 10 as information about the current time of the portable terminal 1, from the portable terminal 1 by way of the data communications means 211. Through processing pertaining to step S38 shown in FIG. 18, the card control means 212 subtracts the value of the reference time data 223 from the current time of the portable terminal 1, to thus compute the time during which the coupon has been utilized up to the present. In the present embodiment, the current time of the portable terminal 1 is November 10; the reference time is November 2; and the time during which the coupon has been utilized is determined by the equation of November 10−November 2=eight days.

Through processing pertaining to S39 in FIG. 18, the card control means 212 compares the time during which the coupon has been utilized up to the present with the remaining time of validity. In the case of the present embodiment, since the time during which the coupon has been utilized up to the present, eight days, is greater than the remaining time of validity, five days, YES is selected through determination processing pertaining to step S39 in FIG. 18. Through processing pertaining to step S40 in FIG. 18, expiration-of-coupon processing is performed. For instance, expiration of a coupon is notified to the portable terminal 1, and a message of invalidity of a coupon, such as expiration of a coupon, is displayed on the display means 11, to thus notify the user of invalidity of the coupon.

(2-3) Operation Performed when a Coupon is Determined to be Valid

Operation performed when a coupon is determined to be valid will now be described as another example of a determination about an expiration date of a coupon in the second embodiment. FIG. 21 is a view showing a specific operation example performed when the validity of the coupon is determined in the second embodiment. The remaining time of validity of the coupon is presumed to be five days; the reference time is November 2; and information about the current time of the portable terminal 1 is presumed to be November 4.

Through processing pertaining to step S37 in FIG. 18, the card control means 212 of the memory card 2 acquires from the portable terminal 1 “November 10” as information about the current time of the portable terminal 1 by way of the data communications means 211. Through processing pertaining to step S38 in FIG. 18, the card control means 212 subtracts the value of the reference time data 223 from the current time of the portable terminal 1, to thus compute the time during which the coupon has been utilized up to the present. In the present embodiment, since the current time of the portable terminal 1 is November 4 and the reference time is November 2, November 4−November 2=two days is determined, to thus compute the time during which the coupon has been utilized.

Through processing pertaining to step S39 in FIG. 18, the card control means 212 compares the thus-determined time during which the coupon has been utilized up to the present with the remaining time of validity. In the case of the present embodiment, the thus-determined time during which the coupon has been utilized up to the present, two days, is smaller than the remaining time of validity of the coupon, five days, determination processing pertaining to step S39 in FIG. 18 becomes NO, and the current coupon is determined to be valid. Processing returns to step S35. In this case, the portable terminal 1 is notified that the coupon is valid, and a message to the effect that a coupon is valid, such as the validity of a coupon, is displayed on the display means 11, to thus notify the user of validity of the coupon.

(2-4) Operation Performed when the Time of the Terminal is Changed

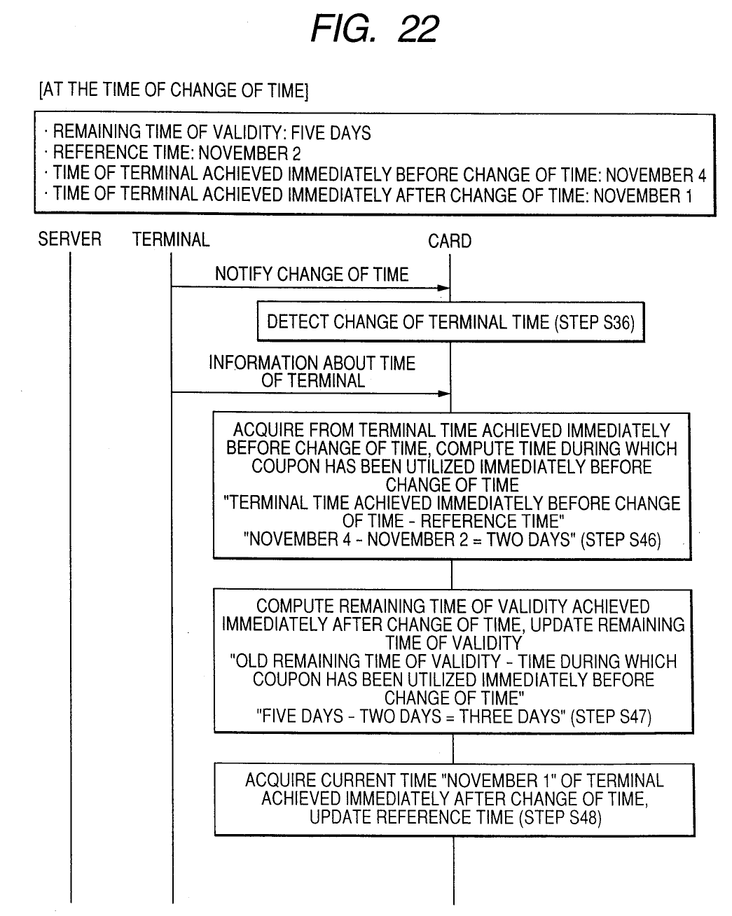

Next, operation of the system performed when the time of the terminal of the second embodiment has been changed will be described. FIG. 22 is a view showing a specific example operation performed when the time of a terminal is changed in the second embodiment. The remaining time of validity of the coupon is presumed to be five days; the reference time is presumed to be November 2; the time achieved immediately before the time of the portable terminal 1 is changed is presumed to be November 4; and the time achieved immediately after the time of the portable terminal 1 is changed is presumed to be November 1.

When the time information about the portable terminal 1 has been changed by the user's operation or the like, the terminal time change notification means 13 of the portable terminal 1 detects that event, and notifies the data communications means 211 of the memory card 2 of the change of time of the terminal. When the memory card 2 has received the notification of change of the terminal time, the card control means 212 detects the change-of-time event of the portable terminal 1 by means of determination processing pertaining to step S36 in FIG. 18. Through processing pertaining to step S46 in FIG. 18, a time of “November 4” achieved immediately before the change of time of the portable terminal 1 is acquired by way of the data communications means 211, and the time during which the coupon has been utilized immediately before the change of time is computed. Specifically, two days are determined by means of subtracting the reference time from the time of the terminal achieved immediately before the change of time of the portable terminal 1; namely, “November 4−November 2.”

Through processing pertaining to step S47 in FIG. 18, the card control means 212 computes the remaining time of validity achieved immediately after the change of time; namely, “old remaining time of validity−time achieved immediately before the change of time of the portable terminal,” i.e., five days−two days=three days, and the thus-determined three days are updated as new remaining-time-of-validity data 224. Through processing pertaining to step S48 in FIG. 18, the card control means 212 acquires time information “November 1” about the portable terminal 1 achieved immediately after the change of time, by way of the data communications means 211, and the thus-acquired November 1 is updated as new reference time data 223.

Therefore, when the time information about the portable terminal 1 has been changed, the reference time data 223 and the remaining-time-of-validity data 224, which are stored in the storage section 22, are updated, in the memory card 2, to new reference time data 223 and new remaining-time-of-validity data 224, which are achieved after the change of time of the terminal, in accordance with the change of the time. On the basis of the new reference time data 223 and the new remaining-time-of-validity data 224, expiration of the coupon or the like is determined.

(2-5) Operation Performed at the Time of Attachment of the Card

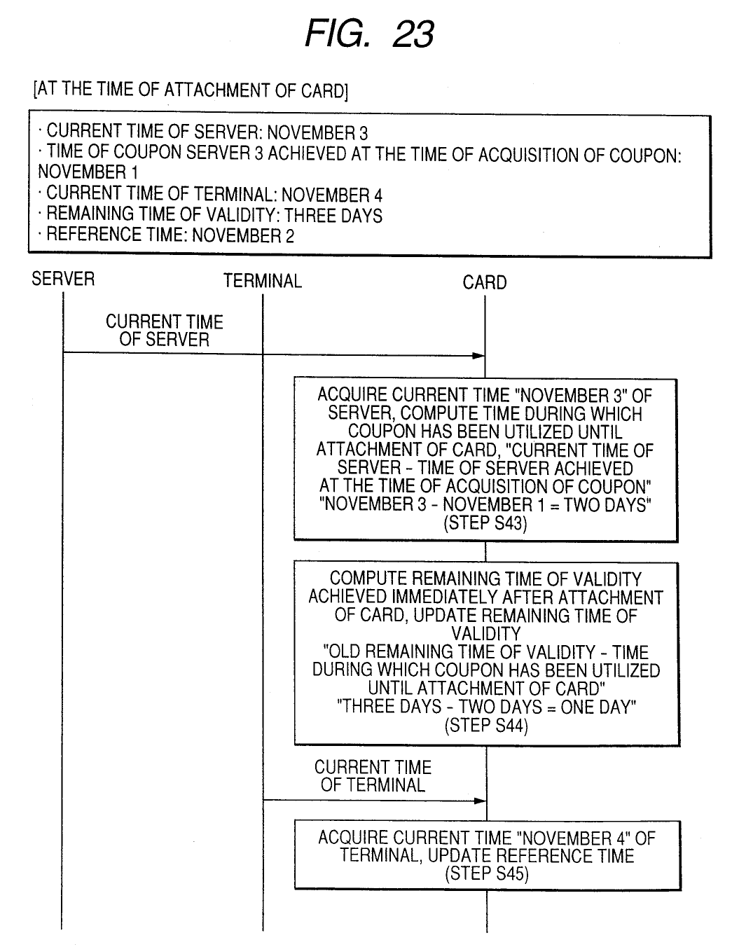

Next, operation performed at the time of attachment of the card in the second embodiment will be described. FIG. 23 is a view showing a specific example operation performed at the time of attachment of a card in the second embodiment. The current time of the coupon server 3 is presumed to be November 3; the time information about the coupon server 3 achieved at the time of acquisition of a coupon; i.e., a time when the coupon has been acquired, is presumed to be November 1; the time information about the portable terminal 1 is presumed to be November 4; the remaining time of validity is presumed to be three days; and the reference time is presumed to be November 2.

When the memory card 2 is attached to the card slot or the like of the portable terminal 1, the data communications means 211 of the memory card 2 is notified of connection of a card by means of the card connection detection means 14 of the portable terminal 1. At that time, when the memory card 2 has received the notification of connection of a card, the card control means 212 detects the event of attachment of the card to the portable terminal 1 by means of determination processing pertaining to step S35 in FIG. 18. Through processing pertaining to step S41 in FIG. 18, the data communications means 211 makes a connection to the coupon server 3. When a connection cannot be established with the coupon server 3, the coupon acquisition time data 225 stored in the storage section 22 are delayed by an amount corresponding to the time during which a connection has not been established with the coupon server 3, by means of processing pertaining to step S42 shown in FIG. 18.

When a connection can have been established with the coupon server 3, the card control means 212 acquires from the coupon server 3 the current time thereof by way of the data communications means 211 through processing pertaining to step S43 shown in FIG. 18, and the time during which the coupon has been utilized until attachment of the memory card is computed. Specifically, the value of the coupon acquisition time data 225 stored in the storage section 22 is subtracted from the current time of the coupon server 3. Namely, two days are determined through November 3−November 1. The thus-acquired current server time is stored in the coupon acquisition time data 225.

Subsequently, through processing pertaining to step S44 in FIG. 18, the card control means 212 computes the remaining time of validity achieved immediately after attachment of the memory card, thereby updating the value of the remaining-time-of-validity data 224 in the storage section 22. Specifically, the time during which the coupon has been utilized until attachment of the memory card 2 is subtracted from the value of the remaining-time-of-validity data 224 which have been stored in the storage section 22 until attachment of the card. Namely, one day is determined by means of computation of three days−two days. This one day is updated as new remaining-time-of-validity data 224. Through processing pertaining to S45 in FIG. 18, the card control means 212 acquires the current time of the portable terminal 1 achieved at the time of acquisition of the server time in step S43. The thus-acquired current time is taken as the time of the terminal achieved at the time of attachment of the card. This terminal time “November 4” is updated as new reference time data 223.

Therefore, when the memory card 2 having the coupon stored therein is newly attached to the portable terminal 1, when the memory card 2 having been temporarily removed from the portable terminal 1 is again attached to the same, when the memory card 2 removed from another portable terminal 1 is attached, or the like, the reference time data 223 and the remaining-time-of-validity data 224, both of which are stored in the storage section 22, are updated, in the memory card 2, to new reference time data 223 and new remaining-time-of-validity data 224 achieved after attachment of the memory card by means of the current time of the coupon serer 3 and the current time of the portable terminal 1. Expiration of a coupon, or the like, is determined on the basis of the new reference time data 223 and the remaining-time-of-validity data 224.

(2-6) Operation Performed at the Time of Acquisition of Information about the Expiration Date of a Coupon

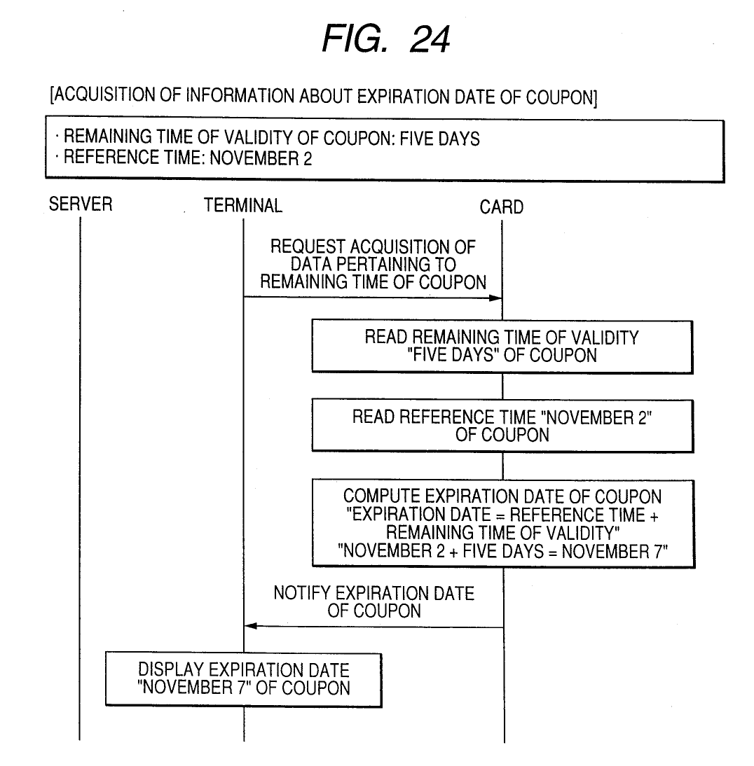

Operation to be performed at the time of acquisition of expiration date information about a coupon in the second embodiment will now be described. FIG. 24 is a view showing a specific example operation performed at the time of acquisition of expiration date information about the coupon in the second embodiment. The remaining time of validity of the coupon is presumed to be five days, and the reference time is presumed to be November 2.

The user performs operation for requesting acquisition of expiration date information about a coupon, by use of the input means 15 of the portable terminal 1. Upon receipt of the request entered by means of the input operation of the user, the portable terminal 1 sends the request for acquisition of expiration date data pertaining to a coupon to the memory card 2 by the data communications means 12. In the memory card 2, when the data communications means 211 has received the request for acquisition of expiration date data pertaining to a coupon, the card control means 212 detects the event; reads the remaining time of validity, five days, and the reference time November 2, both of which are stored in the storage section 22; and adds the remaining time of validity to the reference time, to thus compute the expiration date data November 7 pertaining to the coupon. The data communications means 211 transmits the expiration date data to the portable terminal 1, thereby notifying the expiration date of the coupon.

In the portable terminal 1, when the data communications means 12 has received the expiration date data pertaining to a coupon responding to the request from the user, the display means 11 displays the expiration date information. Thus, the user is notified of the expiration date November 7.

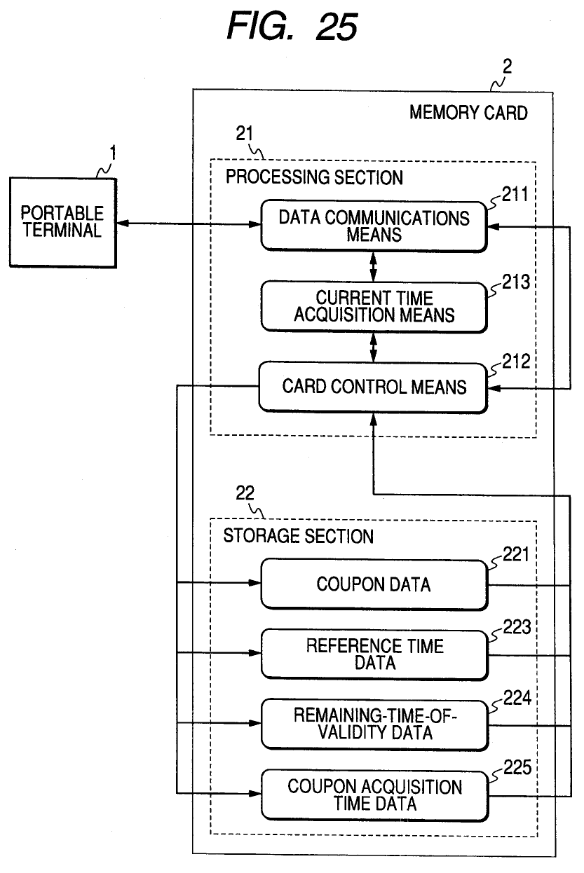

As a first modification of the second embodiment, there may be adopted a configuration where the memory card 2 acquires the current time from the portable terminal 1 in a more independently than does the medium. FIG. 25 is a view showing the functional configuration of a memory card according to a first modification of the second embodiment. In the first modification, the processing section 21 of the memory card 2 has current time acquisition means 213 for independently acquiring the current time of the portable terminal 1. In other respects, the first modification is identical in configuration with the second embodiment shown in FIG. 16. Even in the case of the configuration where the current time acquisition means 213 is provided as mentioned above, the function which is the same as that described in connection with the second embodiment can be acquired.

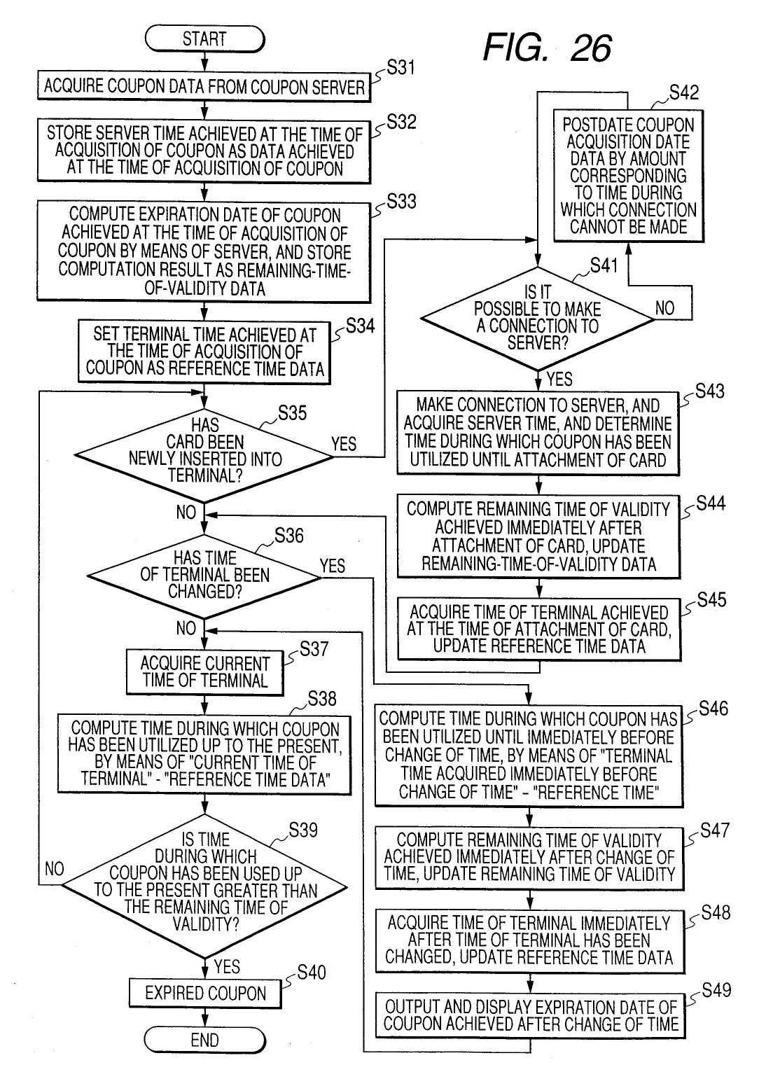

The expiration date achieved after the change of time of the terminal may be displayed on the portable terminal 1 as a second modification of the second embodiment. FIG. 26 is a flowchart showing operation procedures of a memory card according to a second modification of the second embodiment. In the second modification, even when the time information about the portable terminal 1 has been changed through processing pertaining to steps S33 and S46 to S48, the value of the reference time data 223 is subtracted from the time of the terminal achieved immediately before the change of time, to thus compute the time during which the coupon has been utilized immediately before the change of time. The thus-determined time during which the coupon has been utilized immediately before the change of time is subtracted from the value of the remaining-time-of-validity data 224 stored in the storage section 22 immediately before the change of time. The remaining-time-of-validity data 224 stored in the storage section 22 are updated by the thus-obtained remaining time of validity immediately after the change of time. The expiration date data pertaining to the coupon obtained by addition of the updated reference time data 223 to the remaining-time-of-validity data 224 are output and transmitted to the portable terminal 1, thereby displaying the data on the display means 11 of the portable terminal 1 (step S49). In other respects, the second modification is identical in operation with the second embodiment shown in FIG. 18. The expiration data achieved after change of time of the terminal is displayed on the portable terminal 1, whereby the user can ascertain the expiration date achieved after the change of time of the terminal.

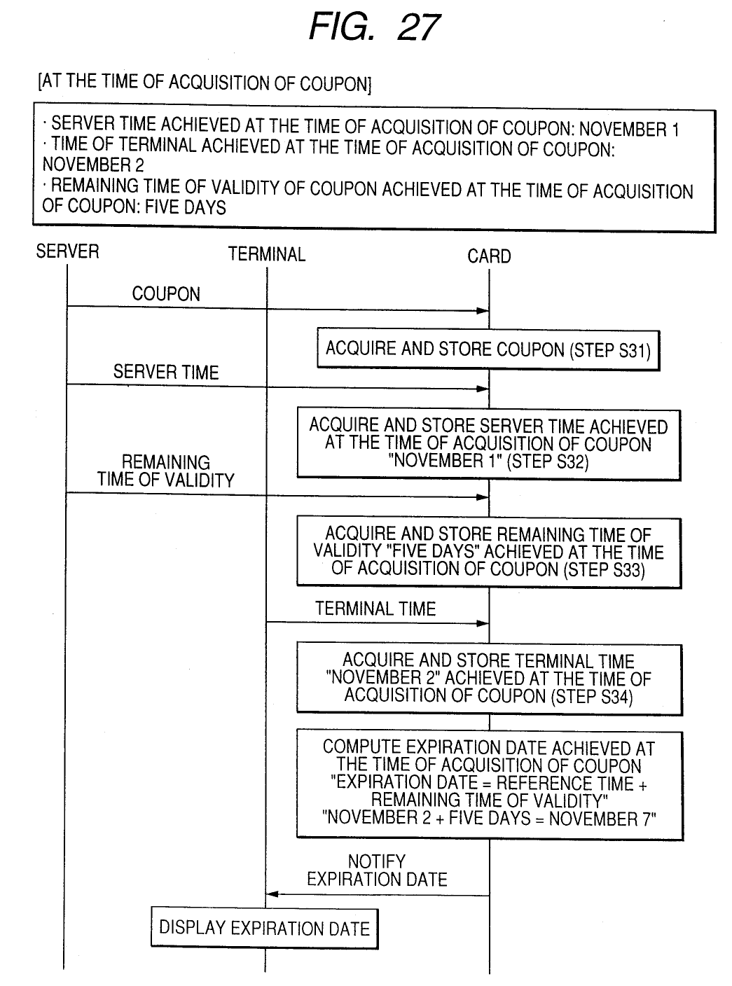

The expiration date may be displayed on the portable terminal 1 at the time of acquisition of a coupon as a third modification of the second embodiment. FIG. 27 is a view showing a specific example operation performed at the time of acquisition of a coupon in a third modification of the second embodiment. In the third modification, the card control means 212 acquires from the coupon server 3 the server time November 1 achieved at the time of acquisition of the coupon and the remaining-time-of-validity of the coupon, i.e., five days. Further, the time of the terminal, i.e., November 2, achieved at the time of acquisition of the coupon is acquired from the portable terminal 1 as a reference time, and the thus-acquired reference time is stored in the storage section 22. The thus-stored remaining-time-of-validity data, five days, and the reference time data November 2 are read and added together, thereby computing the expiration date of the coupon achieved at the time of acquisition thereof. Specifically, November 2+five days=November 7 is computed. The thus-determined expiration date data November 7 are transmitted to the portable terminal 1 by means of the data communications means 211, thereby notifying the expiration date of the coupon. The portable terminal 1 having received the notification displays November 7 as the expiration date of the coupon on the display means 11, and notifies the user of the expiration date. In other respects, the third modification operates in the same manner as the second embodiment shown in FIG. 19. Thus, as a result of the expiration date achieved at the time of acquisition of the coupon being displayed on the portable terminal 1, the user can ascertain the acquired expiration date.

As mentioned above, in the second embodiment, even when the time information about the portable terminal 1 has been changed, the memory card 2 detects the change-of-time event. On the basis of the pieces of time information achieved before and after the change of time of the portable terminal 1, the reference time data 223 and the remaining-time-of-validity data 224, which are used for determining the expiration date of the coupon, may be updated. Thus, the limitation-on-usage information matching the current time of the portable terminal 1, which uses a coupon, at all times is retained in the memory card 2. Hence, the time during which the coupon has been utilized is determined by subtracting the reference time data 223 from the current time of the portable terminal 1, and the thus-determined time is compared with the remaining-time-of-validity data 224, whereby an accurate expiration date of the coupon can be determined at all times. When the memory card 2 is attached to the portable terminal 1, the reference time data 223 and the remaining-time-of-validity date 224 can be updated on the basis of the time information acquired from the coupon server 3 and the time information about the portable terminal 1.

Consequently, as in the case of the first embodiment, even when the user of the portable terminal 1 has changed the time information thereabout, the portable terminal 1 itself can update the correct expiration date without making an access to the coupon server 3 each time, and the current expiration date of the coupon can be accurately grasped and determined. Thus, unauthorized use of a coupon; for instance, the change of time information about the portable terminal 1 intended for using an expired coupon, or the like, can be prevented without making access to the coupon server 3 for checking purpose.

In the second embodiment, the reference time data 223 and the remaining-time-of-validity data 224 are updated on the basis of the time information, or the like, about the portable terminal 1, whereby the validity of the coupon is determined by the data. Accordingly, the burden imposed on the coupon server 3 during expiration date computing processing can be lessened. Namely, in the first embodiment, the coupon server 3 seeks the expiration date of a coupon. Hence, the load, which is imposed on the memory card 2 to determine the validity of the coupon, is lessened. In contrast, in the second embodiment, the load on computing operation imposed when the memory card 2 determines the validity of the coupon is slightly increased. However, the load imposed on the coupon server 3 to perform expiration date computing processing is reduced.

In the present embodiment, a coupon which is one example of contents is considered to include various types of coupons. For instance, the coupon is applicable to a configuration where a free-of-charge or chargeable coupon for use in shops located around a station, where the user is to get off the train, is downloaded from a server of a ticket gate system in a station or a configuration where a free-of-charge or chargeable coupon or a discount coupon is downloaded from a convenience store or the like.

The present embodiment has been described by means of taking the coupon as an example of contents having expiration dates. However, the present invention is not limited to the embodiment. For instance, as a matter of course, the contents may be sound data having expiration dates for free listening, advertisement, or demonstration; chargeable sound data having expiration dates; or composite data consisting of sound and videos, such as a concert video or a movie. The limitation-on-usage information is not limited to an expiration date, and is also applicable to a case where there is used information for specifying limitations on usage of contents, such as copyright information which limits the number of times information is used.

Even in connection with the method for acquiring contents, contents acquired from the content server by use of another terminal for downloading purpose may be written into a memory card, in addition to a method for downloading contents from the content server via the network connected to the portable terminal and writing the thus-downloaded contents into the memory card.

In the above embodiment, the content usage management device has been described by means of taking the memory card as an example. However, the present invention is not limited to the memory card. Any medium can be used, so long as the medium can store contents. For example, even in the case of a device using a recording medium, such as unremovable memory built in a portable terminal, a portable terminal, a compact HDD (hard disk drive) card, a DVD, and the like, the present invention can also be applied in the same manner. The content usage management device may have a data communication function which enables the device to communicate with an external content server. Specifically, the content usage management device is formed from a contactless smart card removably attached to the portable terminal, a contactless IC module built in the portable terminal, or the like, and may be configured so as to acquire and store contents without involvement of the portable terminal.

The change of time of the portable terminal may be notified by the terminal time change notification means in the portable terminal provided with the memory card. Alternatively, the current time acquisition means provided in the memory card may monitor the event of the time of the terminal in the memory card having been changed by the current time acquisition means. Specifically, a certain operation of the portable terminal, such as power-on of the portable terminal, commencement/end of a network connection; commencement/end of communication, activation/deactivation of application, and the like, is taken as a trigger, to thus acquire the current time of the portable terminal and monitor variations in the acquired time. Alternatively, a memory card may incessantly make polling to the portable terminal, to thus acquire the current time of the portable telephone and the change of time of the acquired time.

Although the present invention has been described in detail by reference to specific embodiments, it is manifest for those persons skilled in the art that the present invention can be subjected to various alterations or modifications without departing the scope and spirit of the present invention.

The present application claims priority to Japanese Patent Application No. 2004-004202, filed on Jan. 9, 2004 and No. 2004-269838, filed on Sep. 16, 2004, which are incorporated herein by reference in its entirety.

### INDUSTRIAL APPLICABILITY

The present invention yields an advantage of the ability to correctly determine limitation-on-usage information, such as an expiration date of a content, and the like. The present invention is useful for a content usage management device, or the like, which manages usage of contents being formed from electronic information and liable to limitations, such as coupons, tickets, and the like.

1. A terminal apparatus comprising a content usage management device for managing usage of contents, comprising:
a terminal time change notification unit which automatically notifies the content usage management device of change of time of the terminal apparatus,
wherein the content usage management device comprises:
a change-of-time detection unit which receives a notification of change from the terminal apparatus and detects a change-of-time event at the terminal apparatus; and
a control unit which updates limitation-on-usage information about the contents in accordance with the detected change of time.

2. The terminal apparatus according to claim 1, wherein, when the change-of-time detection unit has detected the change-of-time event of the terminal apparatus, the control unit updates the limitation-on-usage information.

3. The terminal apparatus according to claim 1,
wherein the content usage management device further comprises a data communication unit which transmits and receives data to and from at least a terminal,
wherein the limitation-on-usage information includes expiration data information showing an expiration date by which content can be used, and reference time information showing a reference time which serves as a reference for limitations on usage of the contents,
wherein, when the contents are acquired, the data communications unit transmits and receives data to and from a content distributor which distributes the contents, acquires a remaining time of validity of the contents from the content distributor as the expiration date, and acquires from the terminal a current time thereof as the reference time, and
wherein, when the change-of-time detection unit has detected a change-of-time event of the terminal, the control unit computes a time during which the contents have been used, by means of subtracting the reference time from the current time of the terminal, computes an expiration date achieved immediately after change of the time of the terminal by means of subtracting the time during which the contents have been used from the expiration time achieved immediately before change of time of the terminal, and updates limitation-on-usage information by means of taking the current time of the terminal achieved immediately after change of the time of the terminal as a new reference time.

4. The terminal apparatus according to claim 3, wherein, when the change-of-time detection unit has detected a change-of-time event of the terminal, the data communications unit acquires from the terminal a current time thereof achieved immediately before change of time of the terminal and a current time of the terminal achieved immediately after change of time of the terminal.

5. A content usage management device for managing usage of contents available at a terminal, comprising:
a change-of-time detection unit which detects a change-of-time event at, at least a terminal; and
a control unit which updates limitation-on-usage information about the contents in accordance with the detected change of time,
wherein, when the change-of-time detection unit has detected the change-of-time event of the terminal, the control unit updates the limitation-on-usage information.

6. The content usage management device according to claim 5,
wherein the content usage management device further comprises a data communications unit which transmits and receives data to and from at least a terminal,
wherein the limitation-on-usage information includes expiration date information showing an expiration time by which content can be used and reference time information showing a reference time which serves as a reference for limitations of usage of the contents,
wherein, when the contents are acquires, the data communications unit transmits and receives data to and from a content distributor which distributes the contents, acquires a remaining time of validity of the contents from the content distributor as the expiration date, and acquires from the terminal a current time thereof as the reference time, and
wherein, when the change-of-time detection unit has detected a change-of-time event of the terminal, the control unit computes a time during which the contents have been used, by means of subtracting the reference time from the time of the terminal, computes an expiration date achieved immediately after change of the time of the terminal be means of subtracting the time during which the contents have been used from the expiration time achieved immediately before change of time of the terminal, and updates limitation-on-usage information by means of taking the time of the terminal achieved immediately after change of the time of the terminal as a new reference time.

7. The content usage management device according to claim 6, wherein, when the change-of-time detection unit has detected a change-of-time event of the terminal, the data communications unit acquires from the terminal a time thereof achieved immediately before change of time of the terminal and a time of the terminal achieved immediately after change of time of the terminal.

8-22. (canceled)
